(19) United States
(12) Patent Application Publication
(10) Pub. No.: US 2025/0247244 A1
(43) Pub. Date: Jul. 31, 2025

(54) DATA PROCESSING APPARATUS, DATA PROCESSING METHOD, AND PROGRAM

(71) Applicant: Sony Semiconductor Solutions Corporation, Kanagawa (JP)

(72) Inventors: Akihiko Nagao, Kanagawa (JP); Kumiko Mahara, Kanagawa (JP)

(21) Appl. No.: 18/853,590

(22) PCT Filed: May 1, 2023
(86) PCT No.: PCT/JP2023/017008

§ 371 Date: Apr. 17, 2025

(30) Foreign Application Priority Data
May 18, 2022 (JP) 2022-081283

(51) Int. Cl. H04L 9/32; H04N 23/661

(52) U.S. Cl. CPC H04L 9/3242; H04N 23/662

(57) ABSTRACT

The present technology relates to a data processing apparatus, a data processing method, and a program that enable communication with improved security.

There are provided a register including, as an address region, a setting region that stores setting information transmitted from a host, a security data region that stores security data for the setting information, and a communication information region that stores communication information with the host, and a communication unit that performs register communication between the host and the register, in which communication mode information indicating at least one communication mode of the register communication is written in the communication information region in a case where the communication mode information is received from the host, and a register definition for a same space of the register is set for each of the communication modes based on the communication mode information written in the communication information region. The present technology can be applied to an image sensor and a host that controls the image sensor.

### TECHNICAL FIELD

The present technology relates to a data processing apparatus, a data processing method, and a program, and for example, relates to a data processing apparatus, a data processing method, and a program capable of improving security of communication between an image sensor and a host.

### BACKGROUND ART

There is a technology for improving security regarding transmission of image data from a camera connected to a network (see, for example, Patent Documents 1 and 2). On the other hand, some cameras include a register that stores various types of setting information regarding an imaging condition and the like for an image sensor, various types of setting information regarding transmission of image data from the image sensor to a host inside the camera, and the like.

### CITATION LIST

### Patent Document

Patent Document 1: Japanese Patent Application Laid-Open No. 2019-33368

Patent Document 2: Japanese Translation of PCT International Application Publication No. 2018-525866

### SUMMARY OF THE INVENTION

### Problems to be Solved by the Invention

It is necessary to provide a register space for each of a plurality of functions, such as a case where communication between the image sensor and the host is compatible with a plurality of methods. Since the register space is finite, many functions cannot be applied, or a large register space needs to be prepared.

The present technology has been made in view of such a situation, and enables efficient use of a register space and support of a plurality of functions.

### Solutions to Problems

A data processing apparatus according to one aspect of the present technology is a data processing apparatus including a register including, as an address region, a setting region that stores setting information transmitted from a host, a security data region that stores security data for the setting information, and a communication information region that stores communication information with the host, and a communication unit that performs register communication between the host and the register, in which the data processing apparatus writes communication mode information indicating at least one communication mode of the register communication in the communication information region in a case where the communication mode information is received from the host, and sets a register definition for the same space of the register for each of the communication modes based on the communication mode information written in the communication information region.

A data processing method according to one aspect of the present technology is a data processing method executed by a data processing apparatus including a register including, as an address region, a setting region that stores setting information transmitted from a host, a security data region that stores security data for the setting information, and a communication information region that stores communication information with the host, and a communication unit that performs register communication between the host and the register, the data processing method including writing communication mode information indicating at least one communication mode of the register communication in the communication information region in a case where the communication mode information is received from the host, and setting a register definition for the same space of the register for each of the communication modes based on the communication mode information written in the communication information region.

A program according to one aspect of the present technology is a program for a computer that controls a data processing apparatus including a register including, as an address region, a setting region that stores setting information transmitted from a host, a security data region that stores security data for the setting information, and a communication information region that stores communication information with the host, and a communication unit that performs register communication between the host and the register, the program causing the computer to execute processing including writing communication mode information indicating at least one communication mode of the register communication in the communication information region in a case where the communication mode information is received from the host, and setting a register definition for the same space of the register for each of the communication modes based on the communication mode information written in the communication information region.

In the data processing apparatus, the data processing method, and the program according to one aspect of the present technology, there are provided a register including, as an address region, a setting region that stores setting information transmitted from a host, a security data region that stores security data for the setting information, and a communication information region that stores communication information with the host, and a communication unit that performs register communication between the host and the register, in which communication mode information indicating at least one communication mode of the register communication is written in the communication information region in a case where the communication mode information is received from the host, and a register definition for the same space of the register is set for each of the communication modes based on the communication mode information written in the communication information region.

Note that the data processing apparatus may be an independent apparatus or an internal block included in one apparatus.

Note that a program can be provided by being transmitted via a transmission medium or being recorded on a recording medium.

### BRIEF DESCRIPTION OF DRAWINGS

FIG. 1 is a diagram illustrating an example of a configuration of a data transmission system according to an embodiment of the present disclosure.

FIG. 2 is a diagram illustrating an example of a configuration of a complementary metal-oxide semiconductor (CMOS) image sensor (CIS).

FIG. 3 is a diagram illustrating an example of a configuration of a write determination unit.

FIG. 4 is a diagram for describing a concept of addition of a CRC code.

FIG. 5 is a diagram for describing a concept of MAC addition.

FIG. 6 is a diagram for describing a concept of encrypted data addition.

FIG. 7 is a diagram illustrating an example of a register map.

FIG. 8 is a diagram for describing writing of data in a MAC mode.

FIG. 9 is a diagram for describing writing of data in the CRC mode.

FIG. 10 is a diagram for describing writing of data in an encryption mode.

FIG. 11 is a diagram for describing reading of data in the CRC mode.

FIG. 12 is a diagram for describing reading of data in the encryption mode.

FIG. 13 is a diagram for describing processing states.

FIG. 14 is a diagram for describing a register space in which data is managed.

FIG. 15 is a diagram for describing the register space in which data is managed.

FIG. 16 is a diagram for describing the register space in which data is managed.

FIG. 17 is a diagram for describing the register space in which data is managed.

FIG. 18 is a diagram for describing a configuration of encrypted data.

FIG. 19 is a diagram for describing a format field.

FIG. 20 is a diagram for describing the register space in which data is managed.

FIG. 21 is a diagram for describing data exchanged at the time of authentication.

FIG. 22 is a diagram for describing processing at the time of authentication.

FIG. 23 is a diagram for describing writing of data in a MAC/CRC mode.

FIG. 24 is a diagram for describing writing of data in the encryption mode.

FIG. 25 is a diagram for describing reading of data in the MAC/CRC mode.

FIG. 26 is a diagram for describing reading of data in the encryption mode.

FIG. 27 is a diagram for describing writing of data in an authentication mode.

FIG. 28 is a diagram for describing reading of data in the authentication mode.

FIG. 29 is a diagram illustrating another configuration example of the data transmission system.

FIG. 30 is a diagram for describing processing including switching processing by a Fuse.

FIG. 31 is a diagram for describing a Fuse value.

FIG. 32 is a diagram for describing an example of a configuration of a personal computer (PC).

### MODE FOR CARRYING OUT THE INVENTION

Hereinafter, a mode for carrying out the present technology (hereinafter, referred to as an embodiment) will be described.

### Overall Configuration Example of Data Transmission System

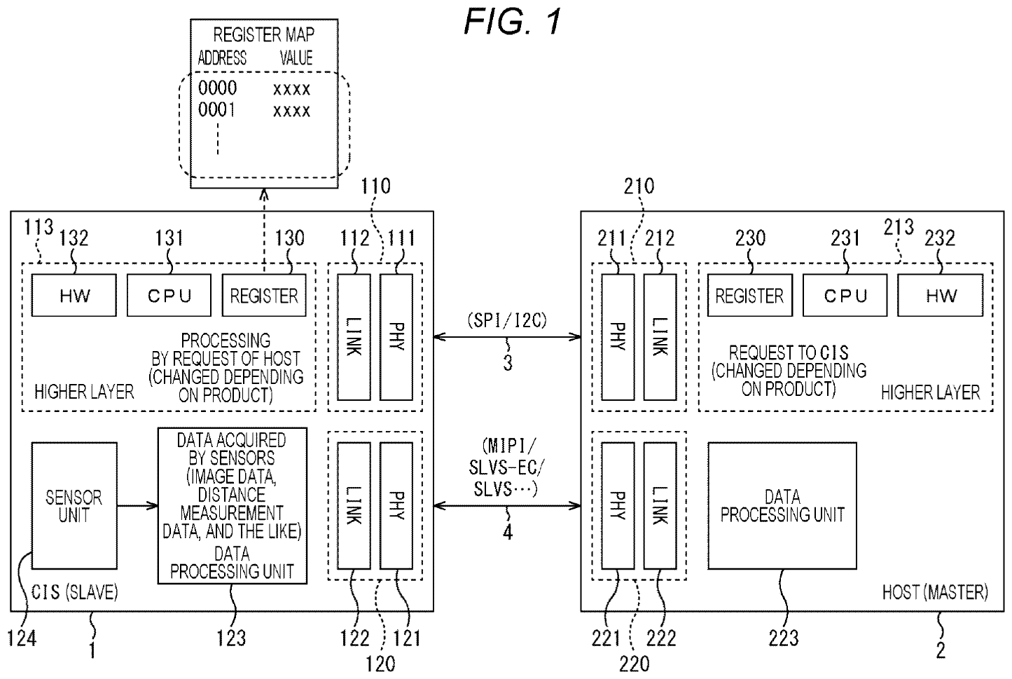

FIG. 1 schematically illustrates an example of an overall configuration of a data transmission system according to an embodiment of the present disclosure.

The data transmission system according to the embodiment relates to, for example, a technology for improving security of register communication between an image sensor (complementary metal-oxide semiconductor (CMOS) image sensor (CIS) 1) inside a camera and a host 2.

The data transmission system illustrated in FIG. 1 includes the CIS 1 as a data processing apparatus, the host 2, a transmission path 3, and a transmission path 4.

The CIS 1 includes a communication unit 110, a higher layer 113, a communication unit 120, a data processing unit 123, and a sensor unit 124.

The communication unit 110 includes a physical layer (PHY) 111 and a link layer (LINK) 112. The communication unit 120 includes a physical layer (PHY) 121 and a link layer (LINK) 122.

The higher layer 113 includes a register 130, a central processing unit (CPU) 131, and hardware (HW) 132. Note that the higher layer 113 may also have a configuration in which the CPU 131 is omitted.

The host 2 includes a communication unit 210, a higher layer 213, a communication unit 220, and a data processing unit 223.

The communication unit 210 includes a physical layer (PHY) 211 and a link layer (LINK) 212. The communication unit 220 includes a physical layer (PHY) 221 and a link layer (LINK) 222.

The higher layer 213 includes a register 230, a CPU 231, and hardware (HW) 232.

The CIS 1 includes a communication interface (IF) (register IF) that performs communication in which the CIS 1 is a slave and the host 2 is a master, and a high-speed IF (data output IF) that outputs large data such as image data acquired by the sensor unit 124.

Each of the communication unit 110 of the CIS 1 and the communication unit 210 of the host 2 constitutes the communication IF (register IF) capable of mutual communication (register communication) between the registers 130 and 230 via the transmission path 3. The register IF may be configured to be capable of switching a plurality of types of IFs by mounting a plurality of types of IFs with different protocols. For example, two types of IFs of a serial peripheral interface (SPI) and an inter integrated circuit (I2C) may be mounted and be switchable.

The communication unit 120 of the CIS 1 constitutes a high-speed IF (data output IF) that outputs large data such as image data acquired from the sensor unit 124 to the communication unit 220 of the host 2 via the transmission path 4. Examples of the high-speed IF include a mobile industry processor interface (MIPI), scalable low voltage signaling with embedded clock (SLVS-EC), and scalable low voltage signaling (SLVS).

The register 130 of the CIS 1 stores setting information transmitted from the host 2 via the register IF. A processing operation of each unit inside the CIS 1 is determined depending on what value is set as the setting information in the register 130. Examples of the setting information include information such as an exposure time, a gain, a resolution (pixel addition and thinning number), a frame rate, a region of interest (ROI), and other operation modes.

The register 130 of the CIS 1 also stores information of various states in the CIS 1, environmental information, and the like. The information of various states, the environmental information, and the like stored in the register 130 can be read from the host 2 via the register IF. Examples of the information of various states, the environmental information, and the like include temperature information inside the CIS 1, metadata in a case where image information from the sensor unit 124 is processed by the data processing unit 123, and error or warning detection information.

In the host 2, the higher layer 213 determines how to cause the CIS 1 to behave, and a value that determines the behavior of the CIS 1 is transmitted as the setting information via the register IF. The host 2 changes the value of the setting information according to the information of various states, the environmental information, and the like read from the register 130 of the CIS 1. Since the behavior of the CIS 1 varies depending on a use case, software (SW) of the CPU 231 of the host 2 is often configured to be rewritable in a relatively easy manner. In a case where the higher layer 213 is implemented by a field programmable gate array (FPGA), both the CPU 231 and the hardware 232 have a variable configuration.

By determining the standards or the like of the physical layers 111 and 211 and the link layers 112 and 212 constituting the register IF by making rules, communication between the CIS 1 and the host 2 can be performed regardless of products. A product-specific portion is only required to be determined only by the higher layers 113 and 213, for example, according to a specification (definition of an address and a value) of the registers 130 and 230 or the like.

For example, how to transmit the setting information in the register IF is defined as a rule in the specifications of the physical layers 111 and 211 and the link layers 112 and 212. As a result, the higher layers 113 and 213 can exchange control information and other information between the CIS 1 and the host 2 via the register IF only by defining the addresses of the registers 130 and 230, an operation in a case where a value is set in the register 130, and the like.

### Circuit Configuration

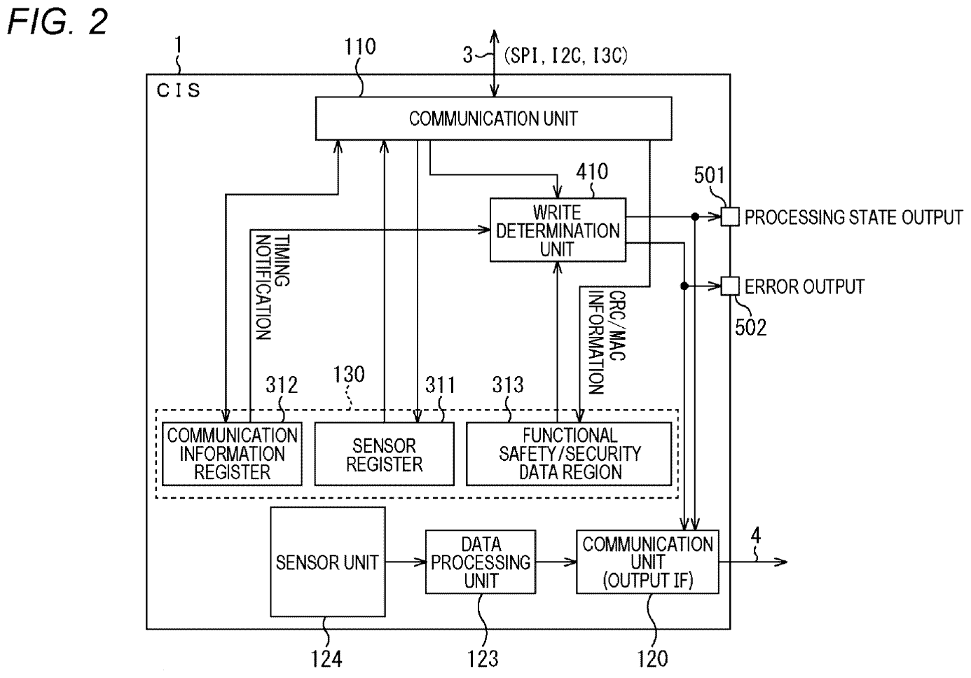

FIG. 2 schematically illustrates an example of a configuration of the CIS 1 as the data processing apparatus. In the configuration example illustrated in FIG. 2, the CIS 1 includes the communication unit 110, the communication unit 120, the data processing unit 123, the sensor unit 124, the register 130, a write determination unit 410, a processing state output terminal 501, and an error output terminal 502.

The processing state output terminal 501 outputs, as notification information, a processing status (processing state FS_S_ACT) indicating a processing state in the register 130 to the host 2. The error output terminal 502 outputs, as notification information, error information (error state FS_S_ERR) generated in processing in the register 130 to the host 2.

The data processing unit 123 performs various types of data processing on sensor data output from the sensor unit 124. The communication unit 120 adds the notification information such as the error information to the sensor data subjected to various types of data processing in the data processing unit 123, and outputs the sensor data to the host 2.

FIG. 2 illustrates a configuration example in a case where, after a setting value is written in a sensor register 311, whether or not the written value is a correct value is determined by, for example, a cyclic redundancy code (CRC) or a message authentication code (MAC).

In the following description, a case where, after writing of the setting value (setting information) to the sensor register 311 is reflected, the determination of whether the setting information reflected in the sensor register 311 is correct or incorrect is performed on the basis of security data will be described as an example. It is also possible to adopt a configuration in which, before writing of the setting information to the sensor register 311 is reflected, whether the setting information reflected in the sensor register 311 is correct or incorrect is determined on the basis of the security data (MAC data or the like), and the setting information is reflected to the sensor register 311 only in a case where the setting information is determined to be correct.

The setting values from the host 2 are sequentially reflected in the sensor register 311 via the communication unit 110. Note that the reflection of the setting value in each unit of the CIS 1 may be made, for example, after latching at a timing of a frame synchronization signal (Frame Sync) of the sensor data.

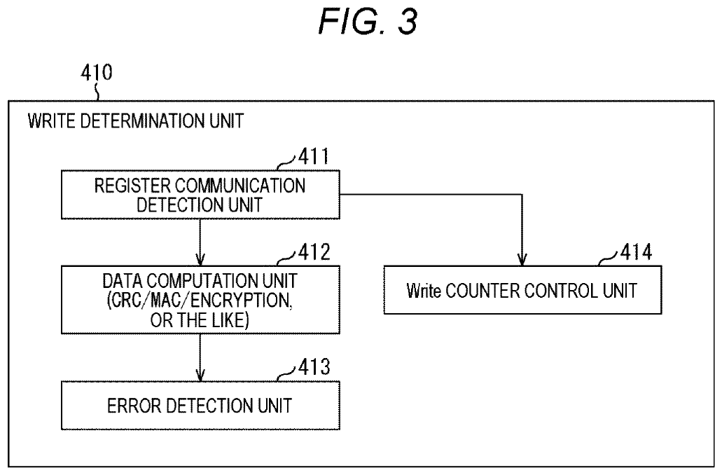

FIG. 3 illustrates a specific example of the write determination unit 410 in the CIS 1 illustrated in FIG. 2.

The write determination unit 410 includes a register communication detection unit 411, a data computation unit 412, an error detection unit 413, and a write counter control unit 414.

The register communication detection unit 411 detects that register communication has been performed. The data computation unit 412 performs computation related to cyclic redundancy check (CRC), the MAC, encryption, and the like. The error detection unit 413 performs error detection based on the computation result of the data computation unit 412. The write counter control unit 414 counts requests for writing to the register 130 on the basis of the detection result of the register communication detection unit 411, and updates a counter value of a write counter of the register 130.

After the writing of the setting information is reflected in the sensor register 311, the write determination unit 410 determines whether the setting information reflected in the sensor register 311 is correct or incorrect on the basis of the security data. As described above, it is also possible to perform determination of whether the setting information reflected in the sensor register 311 is correct or incorrect on the basis of the security data, and reflect the setting information in the sensor register 311 after the setting information is determined to be correct.

A communication information register 312 notifies the write determination unit 410 of a computation start timing and a computation completion timing in the data computation unit 412. In addition, notification of completion of writing of the security data such as CRC data and the MAC data to a functional safety/security data region 313 (determination timing) or the like is made from the communication information register 312.

### General Safety/Security Technology

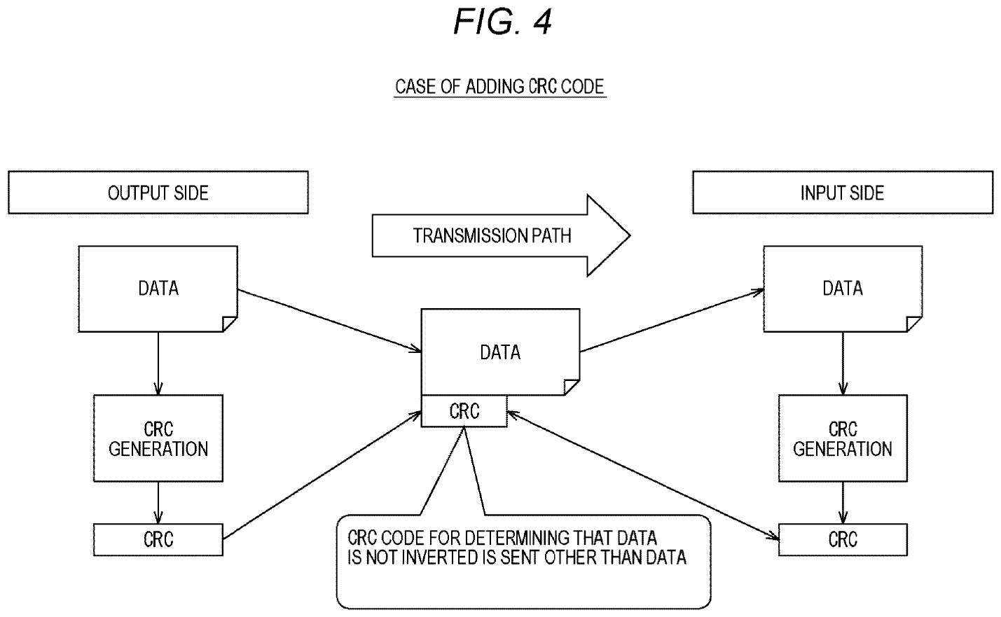

FIG. 4 schematically illustrates an example of communication by addition of a CRC code (error detection code) as a general safety/security technology.

There are CRC (error determination) and ECC (error correction) as functions of detecting inversion of data due to electromagnetic noise or the like. For example, in the CRC, a CRC code for determining that the data is not inverted is added in addition to communication target data. On a data output side, a CRC code is generated on the basis of the data, and the generated CRC code is added to the data and output. On a data input side, a CRC code is generated on the basis of input data, and error determination of the data is performed by comparing the CRC code with the CRC code added to the data.

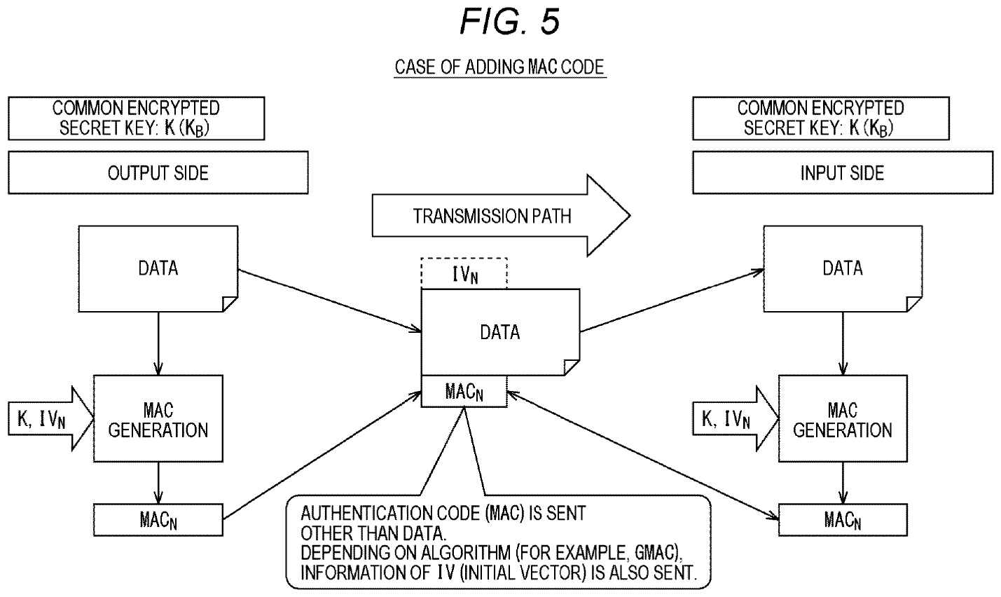

FIG. 5 schematically illustrates an example of communication by message authentication code (MAC) addition as a general safety/security technology.

There is a technology of adding the MAC or a signature to a function of detecting data transmission due to data falsification or spoofing. In general, the MAC is often used for communication requiring a real-time property like the communication IF or the like (a signature may also be used).

In a case of the technology of adding the MAC, a common encryption secret key K (KB) is provided on a data output side and a data input side. On the data output side, the MAC is generated using the common encryption secret key K (KB), and the generated MAC is added to communication target data and output. Depending on a MAC algorithm, initial vector (IV) information is also added and output.

For example, in a case of a cipher-based message authentication code (CMAC), the IV information is not necessary because calculation is performed with IVO, but in a case of using a Galois message authentication code (GMAC), the IV information is also added and output. On the data input side, the MAC is generated using the common encryption secret key K (KB), and is compared with the MAC added to the data to perform data authentication.

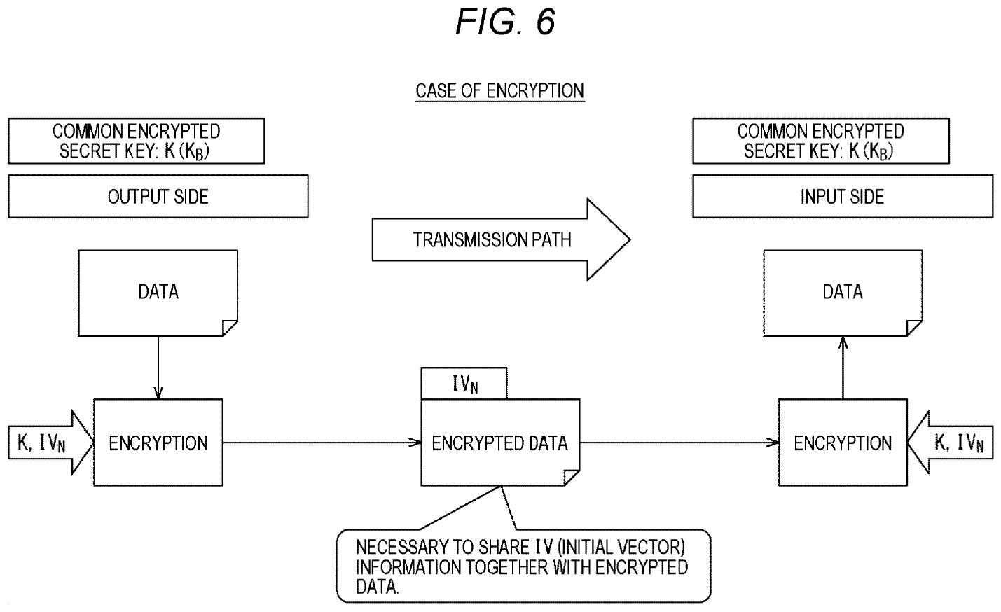

FIG. 6 schematically illustrates an example of communication by encryption as a general safety/security technology.

In order to prevent the data itself from being stolen, an encryption technique may be used. In a case of using the encryption technique, for example, the common encryption secret key K (KB) is provided on the data output side and the data input side. On the data output side, the communication target data is encrypted using the common encryption secret key K (KB) and the IV (initial vector) to generate and output encrypted data. On the data input side, the encrypted data is decrypted using the common encryption secret keys K (KB) and IV.

Hereinafter, a communication mode using MAC is referred to as a MAC mode, a communication mode using CRC is referred to as a CRC mode, and a communication mode using encryption is referred to as an encryption mode.

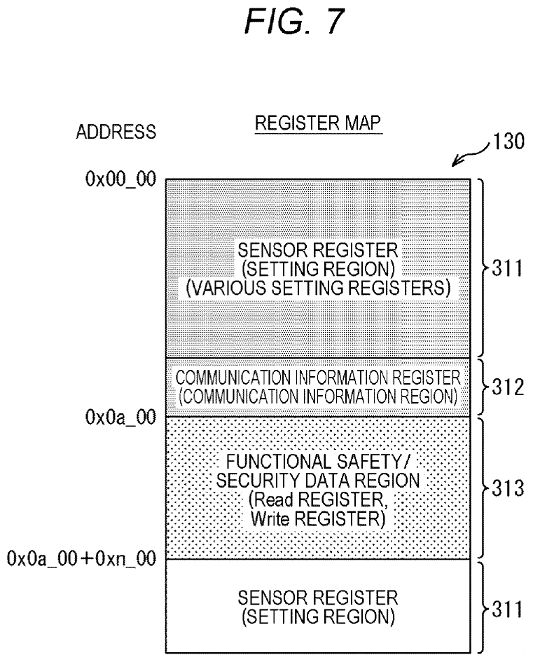

Configuration of Register FIG. 7 illustrates an example of a configuration (register map) of the register 130. Note that an address in the register map illustrated in FIG. 7 is an example, and can be changed as necessary.

The register 130 in the CIS 1 has a setting region (sensor register 311) for storing the setting information transmitted from the host 2 as an address region. In addition to the sensor register 311, a security data region (functional safety/security data region 313) for storing the security data for the setting information as a safety/security address region and a communication information region (communication information register 312) for storing communication information with the host 2 are further provided.

Between the CIS 1 and the host 2, safety/security information is exchanged in the higher layers 113 and 213 by using the safety/security address region in the register 130. A function corresponding to a target connectable by the existing register IF can be selected or changed later, so that safety/security confirmation can be performed in the higher layers 113 and 213 instead of determining by a protocol rule of the register IF. A function of determining whether or not it is the safety/security address region or a function of enabling selection of whether or not to access the safety/security address region may be provided.

As described later, the functional safety/security data region 313 stores, for example, an error detection code (CRC code) related to the setting information and a message authentication code (MAC) related to the setting information as the security data. Furthermore, as described later, the functional safety/security data region 313 stores, for example, encrypted data including the setting information as security data. The functional safety/security data region 313 is, for example, an address region of 256 bytes×n. The functional safety/security data region 313 may include a write register for writing the security data and a read register for reading.

The communication information register 312 is a mode setting register for safety/security. The communication information register 312 stores, as the communication information, for example, communication mode information indicating a communication mode of register communication, status information indicating start of register communication, and status information indicating end of register communication. The communication information is indicated by FS_S_STATE as described later, for example. For example, FS_S_STATE=0 indicates the end of communication, and FS_S_STATE≠0 indicates the start of communication.

Note that, for example, a configuration may be employed so that whether or not to use the functional safety/security data region 313 of the register 130 and the communication information register 312 is switchable by a CPU code or a Fuse in the CIS 1. Furthermore, a configuration may be employed so that which of a plurality of functions of the safety/security technology is used can be switched by the CPU code or the Fuse. The size of the register region can be reduced by using the communication information register 312 and the functional safety/security data region 313 in common for a plurality of functions. It is possible to select which of the plurality of functions to use later by setting at the time of product activation, changing a software part, or switching with the Fuse.

As the address regions of the communication information register 312 and the functional safety/security data region 313, it is sufficient if only the region necessary for the function of a supportable operation mode is prepared among functions of a plurality of safety/security technologies. For example, the address regions of the communication information register 312 and the functional safety/security data region 313 may have a small size unless a large region is required, for example, in a case where only the CRC is supported. When the CIS 1 is compatible with the CRC and the MAC, it is sufficient if only the larger size of the address region necessary for the CRC or the MAC is prepared. Even in a case of configuring to be compatible with both the CRC and the MAC, it is not necessary to prepare both the address region for the CRC and the address region for the MAC.

### Example of Writing of Setting Information in MAC Mode

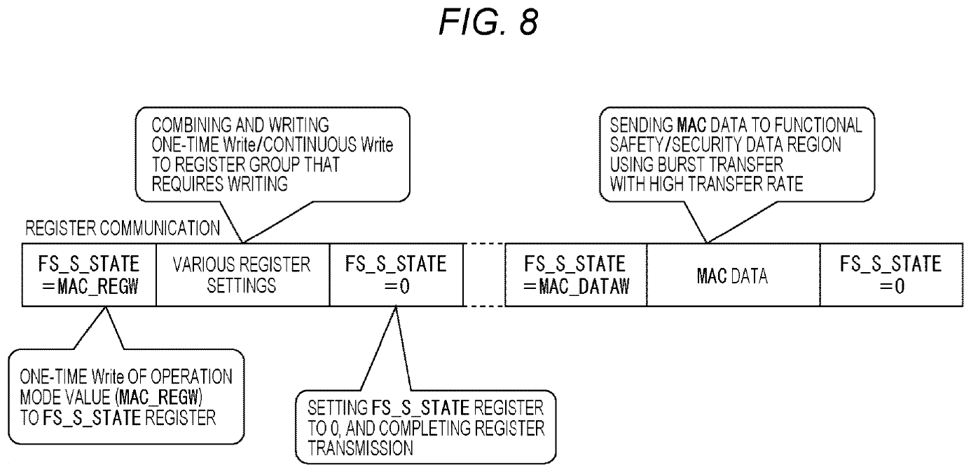

FIG. 8 is a sequence diagram illustrating an example of the register communication. FIG. 8 illustrates an example of register communication in a case where the setting information is written to the sensor register 311 in the MAC mode.

First, a status FS_S_STATE=MAC_REGW indicating a request to start writing the setting information to the sensor register 311 in the MAC mode is transmitted as the communication information from the host 2 via the register IF. The CIS 1 performs one-time write of an operation mode value (MAC_REGW) to an FS_S_STETE register of the communication information register 312.

Next, the setting information to the sensor register 311 is transmitted from the host 2 via the register IF. As the setting information, for example, an address for which the setting value in the sensor register 311 is desired to be changed and a setting value group (a plurality of combinations is possible) are transmitted. In the CIS 1, the setting information is written to the sensor register 311. As a result, various register settings are made in the sensor register 311. In the sensor register 311, one-time write (write) and continuous write (write) may be combined and written to a register group that requires writing.

Next, a status FS_S_STATE=0 indicating a request to end writing the setting information to the sensor register 311 in the MAC mode is transmitted as the communication information from the host 2 via the register IF. In the CIS 1, the operation mode value of the FS_S_STETE register of the communication information register 312 is set to 0.

Next, a status FS_S_STATE=MAC_DATAW indicating a request to start writing the security data in the MAC mode is transmitted as the communication information from the host 2 via the register IF. The CIS 1 performs one-time write of an operation mode value (MAC_DATAW) to the FS_S_STETE register of the communication information register 312.

Next, the security data (MAC data) in the MAC mode is transmitted from the host 2 via the register IF. In the CIS 1, the MAC data is written to the functional safety/security data region 313. The MAC data may be transmitted by burst transfer with a high transfer rate. As the security data, information necessary for processing other than the MAC may also be transmitted. For example, mode information of the MAC in a case where there is a plurality of algorithms and information such as an IV in a case where the GMAC is used may also be transmitted. In a case where a plurality of algorithms can be supported, the operation mode may be fixed in advance at the time of activation of the product, the Fuse, or the like.

Next, a status FS_S_STATE =0 indicating a request to end writing the security data in the MAC mode is transmitted as the communication information from the host 2 via the register IF. In the CIS 1, the operation mode value of the FS_S_STETE register of the communication information register 312 is set to 0.

As described above, by notifying the host 2 of the communication mode as the communication information, the CIS 1 can support a plurality of transfer modes. As described above, by storing the status information indicating the start of communication and the status information indicating the end of communication as the communication information in the communication information register 312, a lump of data can be transmitted from the host 2 regardless of the address region of the register 130 desired to be set, and communication that is not affected by a transfer unit such as burst transfer can be performed. Furthermore, the start of data transmission can be clarified between the host 2 and the CIS 1. A plurality of addresses and data can be collectively subjected to CRC, MAC, or encryption. The data can be transmitted more efficiently than transmitting the CRC data or the MAC data for each transfer unit or the like.

### Example of Writing of Setting Information in CRC Mode

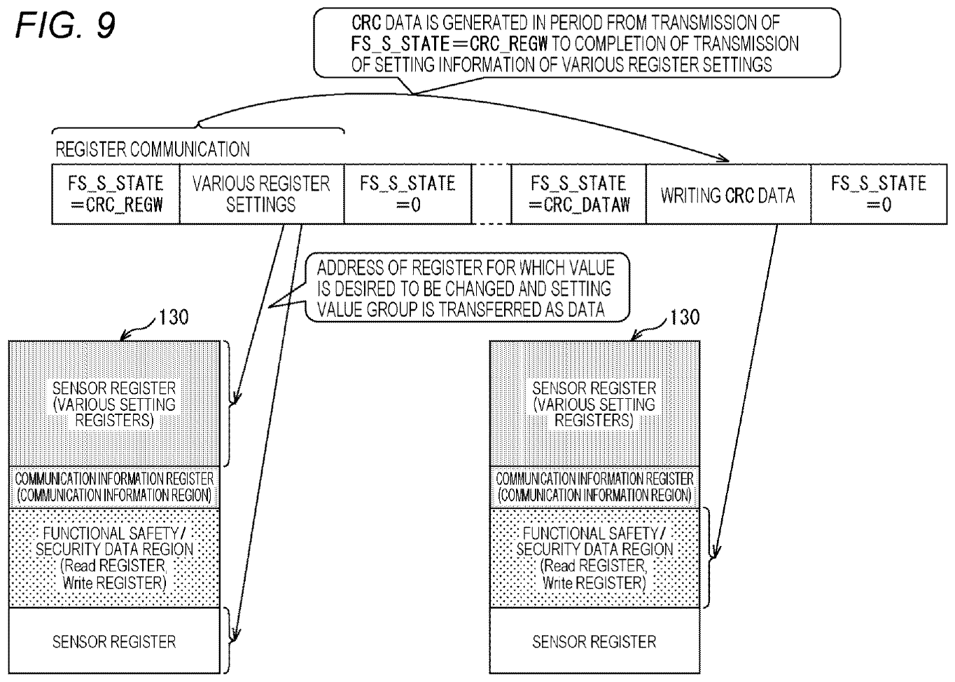

FIG. 9 is a sequence diagram illustrating an example of the register communication. FIG. 9 illustrates an example of register communication in a case where the setting information is written to the sensor register 311 in the CRC mode.

First, a status FS_S_STATE=CRC_REGW indicating a request to start writing the setting information to the sensor register 311 in the CRC mode is transmitted as the communication information from the host 2 via the register IF. As the setting information, for example, an address for which the setting value in the sensor register 311 is desired to be changed and a setting value group (a plurality of combinations is possible) are transmitted. The CIS 1 performs one-time write of an operation mode value (CRC_REGW) to the FS_S_STETE register of the communication information register 312.

Next, the setting information to the sensor register 311 is transmitted from the host 2 via the register IF. In the CIS 1, the setting information is written to the sensor register 311. As a result, various register settings are made in the sensor register 311. In the sensor register 311, one-time write (write) and continuous write (write) may be combined and written to a register group that requires writing.

Next, a status FS_S_STATE=0 indicating a request to end writing the setting information to the sensor register 311 in the CRC mode is transmitted as the communication information from the host 2 via the register IF. In the CIS 1, the operation mode value of the FS_S_STETE register of the communication information register 312 is set to 0.

Next, a status FS_S_STATE=CRC_DATAW indicating a request to start writing the security data in the CRC mode is transmitted as the communication information from the host 2 via the register IF. The CIS 1 performs one-time write of an operation mode value (CRC_DATAW) to the FS_S_STETE register of the communication information register 312.

Next, security data (CRC data) in the CRC mode is transmitted from the host 2 via the register IF. In the CIS 1, the CRC data is written to the functional safety/security data region 313. The CRC data may be transmitted by burst transfer with a high transfer rate. As the security data, information necessary for processing other than the CRC may also be transmitted. For example, mode information of the CRC in a case where there is a plurality of algorithms may also be transmitted. In a case where a plurality of algorithms can be supported, the operation mode may be fixed in advance at the time of activation of the product, the Fuse, or the like. Furthermore, in the CIS 1, the CRC data is generated in a period from transmission of the status FS_S_STATE=CRC_REGW to completion of transmission of the setting information for setting various registers.

Next, a status FS_S_STATE=0 indicating a request to end writing the security data in the CRC mode is transmitted as the communication information from the host 2 via the register IF. In the CIS 1, the operation mode value of the FS_S_STETE register of the communication information register 312 is set to 0.

### Example of Writing Setting Information in Encryption Mode

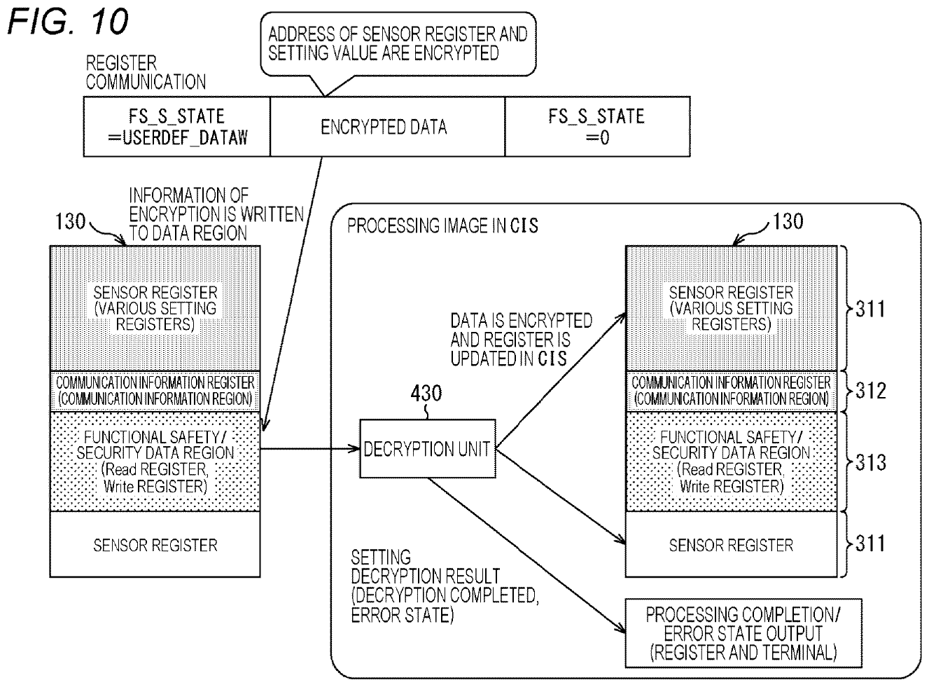

FIG. 10 is a sequence diagram illustrating an example of register communication in the encryption mode.

FIG. 10 illustrates an example of register communication in a case where setting information to be written to the sensor register 311 is encrypted by the encryption mode. The lower right part of FIG. 10 illustrates a processing image in the CIS 1. The CIS 1 includes a decryption unit 430 that decrypts encrypted data.

First, a status FS_S_STATE=USERDEF_DATAW indicating a request to start writing the setting information to the sensor register 311 in the encryption mode is transmitted as the communication information from the host 2 via the register IF. The CIS 1 performs one-time write of an operation mode value (USERDEF_DATAW) to the FS_S_STETE register of the communication information register 312.

Next, encrypted setting information is transmitted as encrypted data from the host 2 via the register IF. Note that the MAC data, the IV, and the like including the setting value of the status FS_S_STATE=USERDEF_DATAW may be encrypted and sent together. In the CIS 1, the encrypted data is written to the functional safety/security data region 313.

Next, in the CIS 1, the decryption unit 430 decrypts the encrypted data, and writes setting information (register address and setting value) obtained by the decryption to the sensor register 311. Note that, in general, authentication (confirmation that data is not falsified) is also performed at the time of decryption. Furthermore, in the CIS 1, a processing completion notification indicating that decryption is completed is performed by the processing state FS_S_ACT. Furthermore, in a case where there is an error, error information is notified by the error state FS_S_ERR.

### Example of Reading of Setting Information in CRC Mode

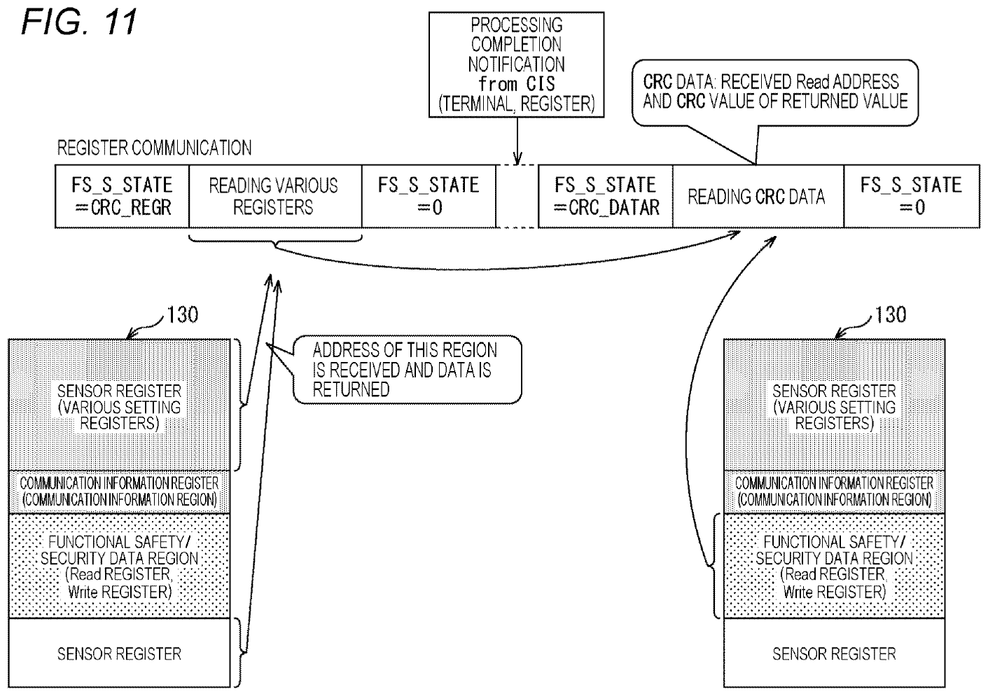

FIG. 11 is a sequence diagram illustrating an example of register communication in a case where reading is performed. FIG. 11 illustrates an example of register communication in a case where a request for reading the setting information stored in the sensor register 311 is made from the host 2 in the CRC mode.

In a case where there is a request for reading setting information from the host 2, the CIS 1 reads the setting information stored in the sensor register 311 and the security data related to the setting information stored in the functional safety/security data region 313, and transmits the read data to the host 2 via the register IF. Note that the operation in the case of performing reading in the MAC mode is basically similar.

First, a status FS_S_STATE=CRC_REGR indicating a request to start reading the setting information in the CRC mode is transmitted as the communication information from the host 2 via the register IF. The CIS 1 performs one-time write of an operation mode value (CRC_REGR) to the FS_S_STETE register of the communication information register 312. The CIS 1 reads the setting information stored in the sensor register 311 and transmits the read data to the host 2 via the register IF. The setting information includes, for example, a register address and a setting value of the sensor register 311 to be read.

Next, a status FS_S_STATE=0 indicating a request to end reading the setting information in the CRC mode is transmitted as the communication information from the host 2 via the register IF. In the CIS 1, the operation mode value of the FS_S_STETE register of the communication information register 312 is set to 0. Next, in the CIS 1, for example, a completion notification indicating that read processing is completed is performed by the processing state FS_S_ACT. The notification may be made using the processing state output terminal 501 or the register IF.

Next, a status FS_S_STATE=CRC_DATAR indicating a request to start reading security data in the CRC mode is transmitted as the communication information from the host 2 via the register IF. The CIS 1 performs one-time write of an operation mode value (CRC_DATAR) to the FS_S_STETE register of the communication information register 312.

Next, the CIS 1 generates CRC data and writes the CRC data in the functional safety/security data region 313. Next, the CIS 1 reads the CRC data from the functional safety/security data region 313, and transmits the CRC data as security data to the host 2 via the register IF. The CRC data may include a register address and a CRC value of the sensor register 311 to be read. As the security data, information necessary for processing other than the CRC may also be transmitted. For example, mode information of the CRC in a case where there is a plurality of algorithms may also be transmitted.

Next, a status FS_S_STATE=0 indicating a request to end reading the security data in the CRC mode is transmitted as the communication information from the host 2 via the register IF. In the CIS 1, the operation mode value of the FS_S_STETE register of the communication information register 312 is set to 0.

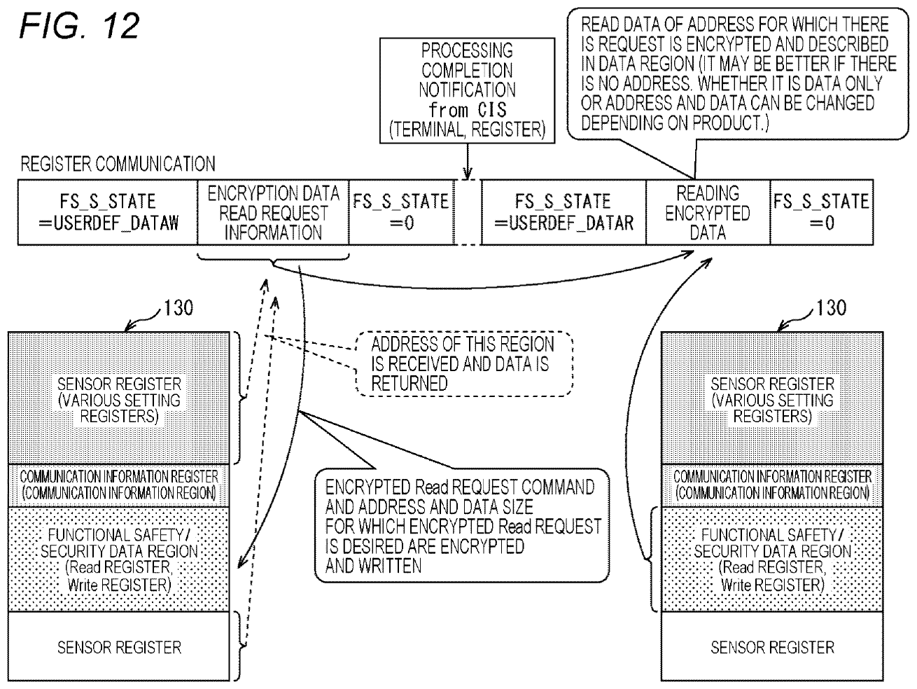

Example of Reading Setting Information in Encryption Mode FIG. 12 is a sequence diagram illustrating an example of register communication in a case where reading in the encryption mode is performed. FIG. 12 illustrates an example of register communication in a case where a request for reading the setting information stored in the sensor register 311 is made from the host 2 in the encryption mode.

In a case where there is a request for reading the setting information in the encryption mode from the host 2, the CIS 1 encrypts the setting information stored in the sensor register 311 and writes the encrypted information as encrypted data in the functional safety/security data region 313, and then reads the encrypted data from the functional safety/security data region 313.

First, the status FS_S_STATE=USERDEF_DATAW indicating a request to start writing the setting information to the functional safety/security data region 313 in the encryption mode is transmitted as the communication information from the host 2 via the register IF. The CIS 1 performs one-time write of the operation mode value (USERDEF_DATAW) to the FS_S_STETE register of the communication information register 312.

In the CIS 1, the setting information stored in the sensor register 311 is read, and the setting information is encrypted and written in the functional safety/security data region 313 as encrypted data. The encrypted data may include an encrypted read request command and an address and a data size of the sensor register 311 that is a target of the encrypted read request. It may be better not to include an address. Whether or not the address is included depends on the product.

Next, a status FS_S_STATE=0 indicating a request to end writing is transmitted as the communication information from the host 2 via the register IF. In the CIS 1, the operation mode value of the FS_S_STETE register of the communication information register 312 is set to 0.

Next, in the CIS 1, for example, a completion notification indicating that write processing is completed is performed by the processing state FS_S_ACT. The notification may be made using the processing state output terminal 501 or the register IF.

Next, a status FS_S_STATE =USERDEF_DATAR indicating a request to start reading the setting information in the encryption mode (an encrypted read request command) is transmitted as the communication information from the host 2 via the register IF. The CIS 1 performs one-time write of the operation mode value (USERDEF_DATAR) to the FS_S_STETE register of the communication information register 312. The CIS 1 reads the encrypted data from the functional safety/security data region 313 and transmits the encrypted data to the host 2 via the register IF.

Next, a status FS_S_STATE=0 indicating a request to end reading is transmitted as the communication information from the host 2 via the register IF. In the CIS 1, the operation mode value of the FS_S_STETE register of the communication information register 312 is set to 0.

### State Notification

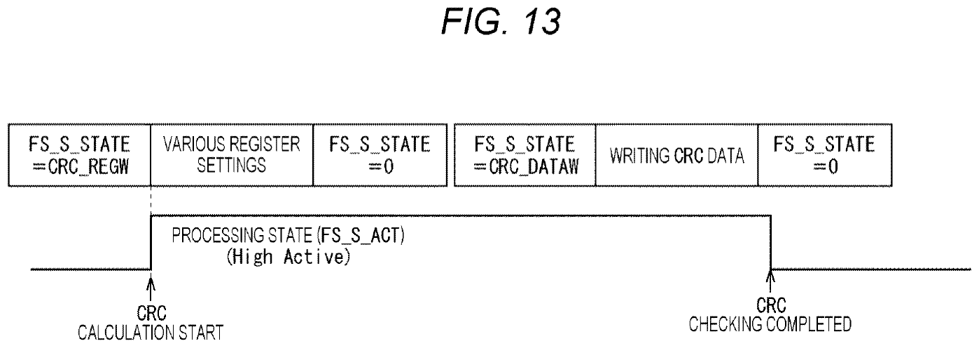

FIG. 13 is a sequence diagram illustrating an example of the register communication. FIG. 13 illustrates an example of state notification in the CIS 1 in a case where the setting information is written in the CRC mode.

The processing state FS_S_ACT indicates Active when it is High, for example. By seeing that the processing state FS_S_ACT becomes Low, it can be seen that the writing of the setting value to the sensor register 311 has ended. If no error is detected while the error state FS_S_ERR remains Low, the reflection of the setting value on the sensor register 311 has ended at the time when the processing state FS_S_ACT becomes Low. The error state FS_S_ERR indicates Active when being Low, for example.

As described above, as the safety functions in the CIS 1, there are CRC check of write data and CRC addition to read data, and as the security functions, there are authentication at startup, encryption of write or read data during steady operation, and MAC. Various methods such as ISO9798 and ISO11770 are defined as authentication and key exchange methods. In order to support these functions and communication schemes on the CIS 1 side, it is necessary to prepare a register region for each function in the register space of the register 130 of the CIS 1.

However, the register space of the register 130 of the CIS 1 is limited, and it is necessary to have a larger register space in order to configure to support many functions and communication schemes. Furthermore, as described above, depending on the type of data, there is a case where it is desired to set data as one-time data (in the above example, described as one-time write), a case where it is desired to set data as continuous data (in the above example, continuous Write is described) and it is desired to write data of a block in a continuous address, and the like.

For example, the single data includes scene change information such as an exposure time and an analog gain. Examples of the continuous data include mode transition, condition setting at the time of activation, and reading of metadata in the sensor (in the CIS 1). In a case where the CIS 1 is equipped with AI, dictionary data and the like are also set as continuous data. When such single data or continuous data is sent, an efficient format is also required as functional safety and security data.

Hereinafter, a description will be added to enable support for many functions without increasing the region of the register of the register 130.

### Sharing of Register Region

A case where the region of the register 130 is shared by a plurality of modes will be described. Examples of the plurality of modes include a MAC mode which is a communication mode using the MAC described above, a CRC mode which is a communication mode using CRC, and an encryption mode which is a communication mode using encryption. Furthermore, here, instead of these modes, a communication mode for performing conventional communication is prepared, and the mode is set as a conventional mode. In addition, here, there is also a communication mode using authentication data, and the mode is set as an authentication mode.

The register 130 performs an operation based on a set mode among these modes. In the register 130, for example, in a case where data A is written in a register space A and the mode is the CRC mode, the data A is treated as data in the CRC mode. In a case where the data A is written in the register space A and the mode is the MAC mode, the data A is handled as data in the MAC mode.

That is, even in the same register space A, data being written (to be written) in the register space A is treated as data corresponding to the set mode. The register 130 is switched and used by a plurality of modes, in other words, the register space is shared and used by a plurality of modes, so that the register 130 having a space region of a predetermined size can be effectively used. This point will be further described.

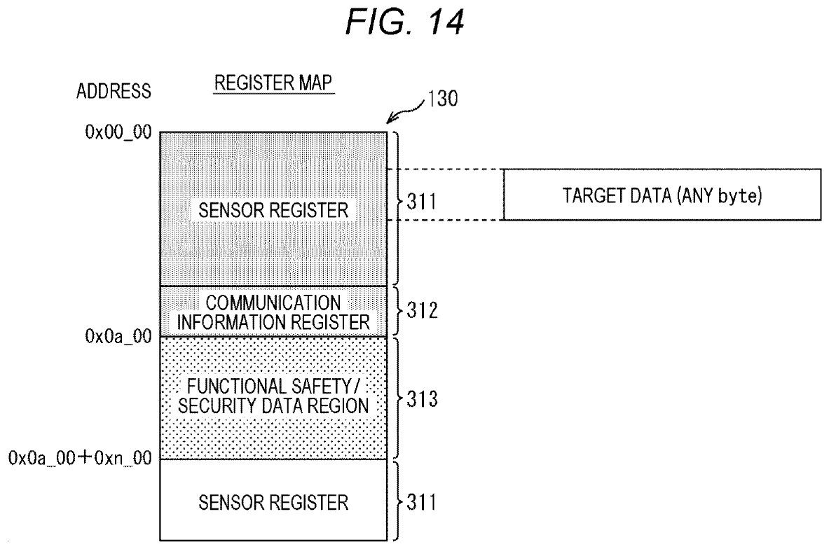

FIG. 14 is a diagram for describing data to be written or being written in the register 130 in communication when the conventional mode is set. In a case where the mode is set to the conventional mode, in other words, in a case where the mode is not designated by a command, target data (any number of bytes) to be written or read from the host 2 is managed by the sensor register 311 of the register 130.

For example, in a case where there is no designation by a command such as a functional safety command or a security command to be described later, the communication information register is in a state where the command is not managed, and in such a state, the register 130 operates on the assumption that the mode is the conventional mode. The target data requested to be written from the host 2 to the register 130 is written to the sensor register 311 of the register 130. In a case where the mode is set to the conventional mode, target data requested to be read from the register 130 by the host 2 is read from the sensor register 311 of the register 130.

The managed region is the same between a case where there is a request for writing to the register 130 and a case where there is a request for reading from the register 130, and thus a case where there is a request for writing to the register 130 will be mainly described in the following description.

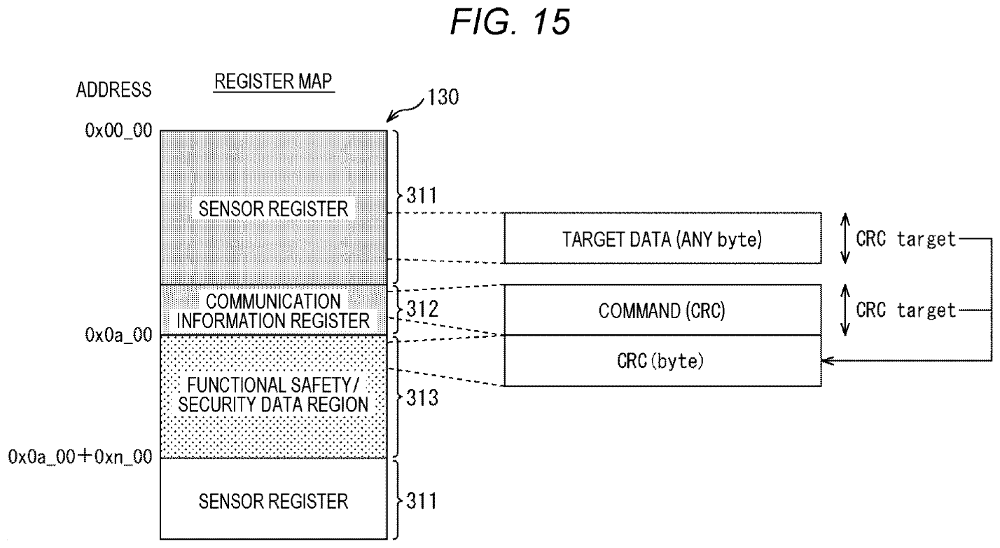

FIG. 15 is a diagram for describing data to be written or being written in the register 130 in communication when a functional safety command (CRC) is set.

The setting of the functional safety command (CRC) is set when a command to set the CRC mode is received from the host 2. Specifically, in a case where the command (CRC) is written in the communication information register 312, the register 130 operates as managing data in the CRC mode.

In a case where the mode is set to the CRC mode, target data (any number of bytes) requested to be written from the host 2 to the register 130 is written to the sensor register 311 of the register 130, a command (CRC) is written to the communication information register 312, and CRC data (for example, 4 bytes) is written to the functional safety/security data region 313.

As illustrated in FIG. 15, the CRC data is data generated with the target data and the command (CRC) as computation targets of the CRC. When the target data is received, such as CRC data, data that is temporarily referred to for verifying the safety or the like, or data whose address itself is better to be kept concealed regarding which region in the register 130 it is managed is managed in the functional safety/security data region 313.

Referring to the case of the conventional mode illustrated in FIG. 14 and the case of the CRC mode illustrated in FIG. 15, the target data is managed by the sensor register 311 in both cases. Even target data managed in the same register space of the sensor register 311 is treated as target data in the conventional mode in a case of being set to the conventional mode, and is treated as target data in the CRC mode in a case of being set to the CRC mode. That is, even data managed in the same register space is handled differently depending on the set mode.

By defining a plurality of registers in the same register space for each command definition, the same register space can be shared and used in a plurality of modes, and processing corresponding to a plurality of functions can be executed using a finite register space. The CIS 1 including such a register 130 can support a plurality of functions with enhanced functional safety and security functions.

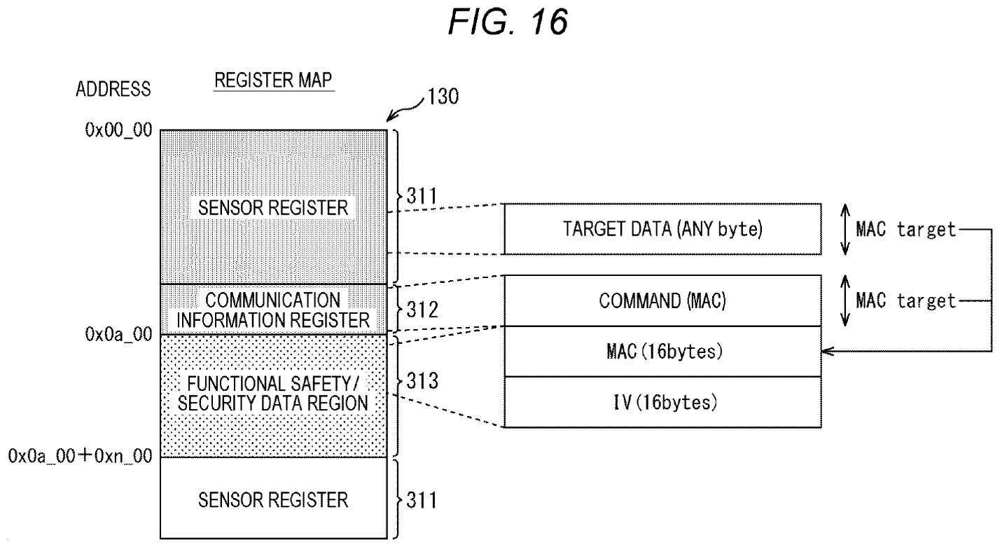

FIG. 16 is a diagram for describing data to be written or being written in the register 130 in communication when a security command (MAC) is set. Setting of the security command (MAC) is set when a command to set the MAC mode is received from the host 2, and the command (MAC) is managed by the communication information register 312.

The command (MAC) from the register 130 from the host 2 is written in the communication information register 312. In a case where the mode is set to the MAC mode, the target data (any number of bytes) which is requested to be written to the register 130 from the host 2 is written to the sensor register 311 of the register 130, and the MAC data (for example, 16 bytes) and the initial vector (IV) (for example, 16 bytes) are written to the functional safety/security data region 313.

As illustrated in FIG. 16, the MAC data is data generated with the target data and a command (MAC) as computation targets of the MAC data.

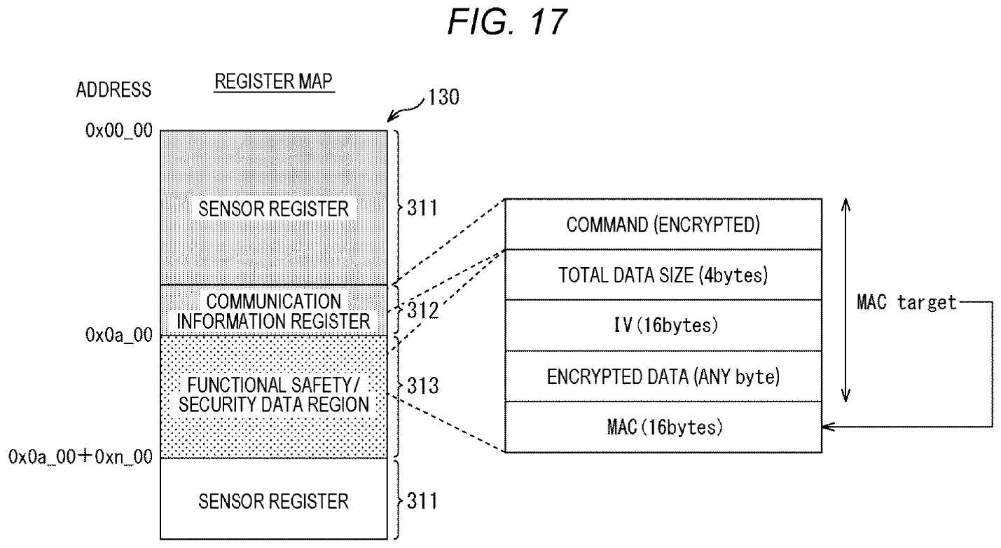

FIG. 17 is a diagram for describing data to be written or being written in the register 130 in communication when a security command (encryption) is set. The setting of the security command (encryption) is set when a command to set the encryption mode is received from the host 2 and the command (encryption) is managed by the communication information register 312.

A command (encryption) from the register 130 from the host 2 is written in the communication information register 312. The target data requested to be written from the host 2 to the register 130 is written to the functional safety/security data region 313 as encrypted data (any number of bytes). In the functional safety/security data region 313, the total data size (for example, 4 bytes), IV (for example, 16 bytes), and MAC data (for example, 16 bytes) are also written.

The target data to be written is encrypted, supplied from the host 2, and written in the functional safety/security data region 313 while being encrypted. In order to conceal address information itself indicating in which space of the register 130 the encrypted data is written (whether the encrypted data is written) from an attacker or the like, the encrypted data is written in the functional safety/security data region 313.

As illustrated in FIG. 17, the MAC data is data generated with a command (encryption), a total data size, and encrypted data as computation targets of the MAC data.

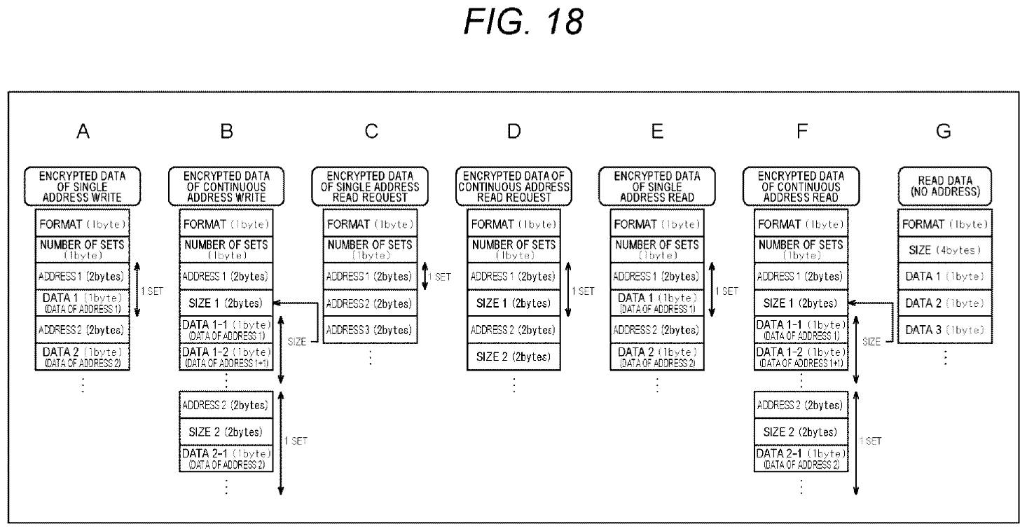

The encrypted data managed in the functional safety/security data region 313 has a format as illustrated in FIG. 18. At the time of an encryption command, a format in which burst transfer and single transfer are possible in encrypted data is defined.

The format illustrated in A of FIG. 18 is single address data and indicates the format of encrypted data at the time of write. In the format illustrated in A of FIG. 18, a format field (for example, 1 byte), a set number field (for example, 1 byte), an address 1 field (for example, 2 bytes), a data 1 field (data of address 1, for example, 1 byte), an address 2 field (for example, 2 bytes), and a data 2 field (data of address 2, for example, 1 byte) . . . are arranged in order from the top in the drawing.

An address field and a data field, for example, an address 1 field and a data 1 field are one set, and the number of such sets including an address field and a data field is described in the set number field.

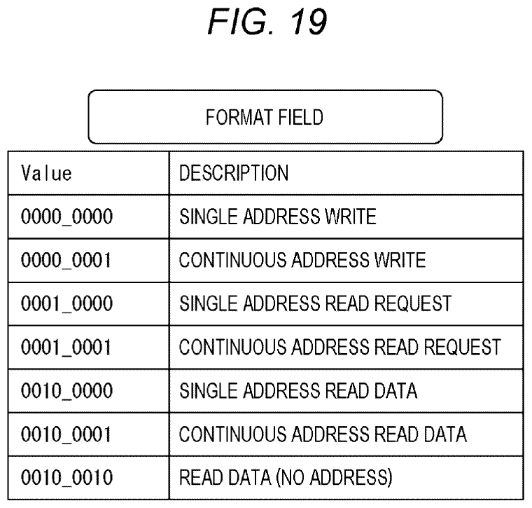

An example of values described in the format field is illustrated in FIG. 19. In a case of a single address WRITE, a value “0000_0000” is described in the format field.

The format illustrated in B of FIG. 18 is continuous address data and indicates the format of encrypted data at the time of write. In the format illustrated in B of FIG. 18, a format field (for example, 1 byte), a set number field (for example, 1 byte), an address 1 field (for example, 2 bytes), a size 1 field (for example, 2 bytes), a data 1-1 field (data of address 1, for example, 1 byte), a data 1-2 field (data of address 1+1, for example, 1 byte), . . . , an address 2 field (for example, 2 bytes), a size 2 field (for example, 2 bytes), and a data 2-1 field (data of address 2, for example, 1 byte) . . . are arranged in order from the top in the drawing.

An address field and a data field, for example, the data 1-1 field and the data 1-2 field . . . arranged before the address 2 field from the address 1 field are one set, and the number of such sets including an address field and a plurality of data fields is described in the set number field.

In a size field, the total number of bytes of the data field included in the set is described. The size 1 field describes the total number of bytes of data fields included in one set including the data 1-1 field, the data 1-2 field,., for example.

Referring to FIG. 19, in a case of the continuous address WRITE, a value “0000_0001” is described in the format field.

The format illustrated in C of FIG. 18 is single address data, and indicates the format of encrypted data at the time of a read request. In the format illustrated in C of FIG. 18, a format field (for example, 1 byte), a set number field (for example, 1 byte), an address 1field (for example, 2 bytes), an address 2 field (for example, 2 bytes), and an address 3 field (for example, 2 bytes) . . . are arranged in order from the top in the drawing.

One address field is regarded as one set, and the number of such sets is described in the set number field.

Referring to FIG. 19, in a case of a single address READ request, a value “0001_0000” is described in the format field.

The format illustrated in D of FIG. 18 is continuous address data and indicates the format of encrypted data at the time of a read (READ) request. In the format illustrated in D of FIG. 18, a format field (for example, 1 byte), a set number field (for example, 1 byte), an address 1 field (for example, 2 bytes), a size 1 field (for example, 2 bytes), an address 2 field (for example, 2 bytes), and a size 2 field (for example, 2 bytes) . . . are arranged in order from the top in the drawing.

An address field and a size field, for example, the address 1 field and the size 1 field are one set, and the number of such sets including an address field and a size field is described in the set number field.

In the size field, the number of bytes of addresses included in the set is described. For example, in the size 1 field, the number of bytes of the address 1 field is described.

Referring to FIG. 19, in a case of a continuous address READ request, a value “0001_0001” is described in the format field.

The format illustrated in E of FIG. 18 is single address data, and indicates the format of encrypted data at the time of reading (READ). In the format illustrated in E of FIG. 18, a format field (for example, 1 byte), a set number field (for example, 1 byte), an address 1field (for example, 2 bytes), a data 1 field (data of address 1, for example, 1 byte)), an address 2 field (for example, 2 bytes), and a data 2 field (data of address 2, for example, 1 byte) . . . are arranged in this order from the top in the drawing.

An address field and a data field, for example, an address 1 field and a data 1 field are one set, and the number of such sets including an address field and a data field is described in the set number field.

Referring to FIG. 19, in a case of single address READ data, a value “0010_0000” is described in the format field.

The format illustrated in F of FIG. 18 is continuous address data and indicates the format of encrypted data at the time of reading (READ). In the format illustrated in F of FIG. 18, a format field (for example, 1 byte), a set number field (for example, 1 byte), an address 1 field (for example, 2 bytes), a size 1 field (for example, 2 bytes), a data 1-1 field (data of address 1, for example, 1 byte), a data 1-2 field (data of address 1+1, for example, 1 byte), . . . , an address 2 field (for example, 2 bytes), a size 2 field (for example, 2 bytes), and a data 2-1 field (data of address 2, for example, 2 bytes). are arranged in order from the top in the drawing.

An address field and a data field, for example, the data 1-1 field and the data 1-2 field . . . arranged before the address 2 field from the address 1 field are one set, and the number of such sets including an address field and a plurality of data fields is described in the set number field.

In a size field, the total number of bytes of the data field included in the set is described. The size 1 field describes the total number of bytes of data fields included in one set including the data 1-1 field, the data 1-2 field, . . . , for example.

Referring to FIG. 19, in a case of a continuous address READ, a value “0010_0001” is described in the format field.

The format illustrated in G of FIG. 18 indicates the format of read data having no address. In the format illustrated in G of FIG. 18, a format field (for example, 1 byte), a size field (for example, 4 bytes), a data 1 field (for example, 1 byte), a data 2 field (for example, 1 byte), and a data 3 field (for example, 1 byte) . . . are arranged in this order from the top in the drawing.

Referring to FIG. 19, in a case of READ data (no address), a value of “0010_0010” is described in the format field.

The single address data is used, for example, in a case where it is desired to transmit scene change information such as an exposure time and an analog gain.

The continuous address data is used in a case of mode transition, condition setting at startup, reading of metadata in the CIS 1, and the like. In a case where AI is installed in the CIS 1, the continuous address data is also used in a case where dictionary data or the like is desired to be transmitted.

In the present embodiment, encrypted data corresponding to a plurality of formats as illustrated in FIG. 18 can be managed by the register 130. Even in a case where such encrypted data is handled, efficient data communication can be performed.

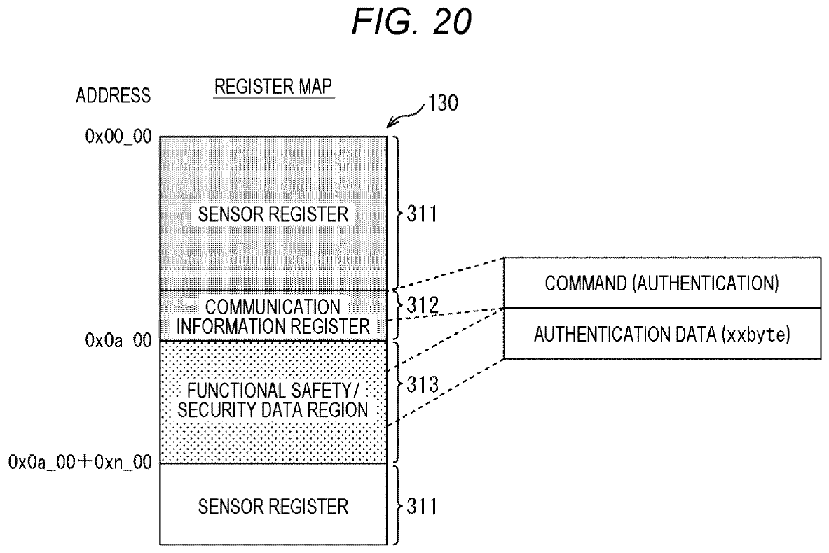

FIG. 20 is a diagram for describing data to be written or being written in the register 130 in communication when the authentication command is set. The setting of the authentication command is set when a command to set the authentication mode is received from the host 2 and the command (authentication) is managed by the communication information register 312.

The authentication data (xx byte) requested to be written from the host 2 to the register 130 is written to the functional safety/security data region 313.

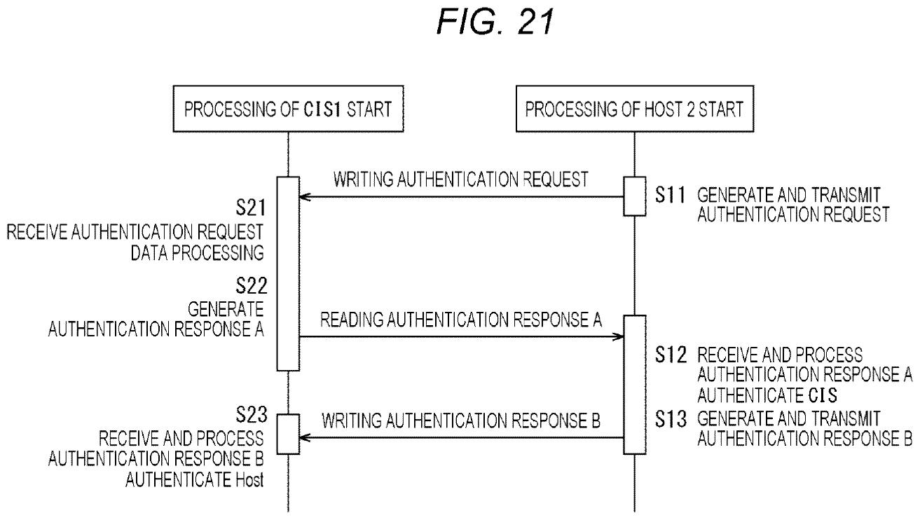

Processing of exchanging authentication data between the CIS 1 and the host 2 will be described with reference to the timing chart illustrated in FIG. 21.

In step S11, the host 2 generates an authentication request and transmits the authentication request to the CIS 1. In step S21, the CIS 1 receives an authentication request from the host 2 and processes the data.

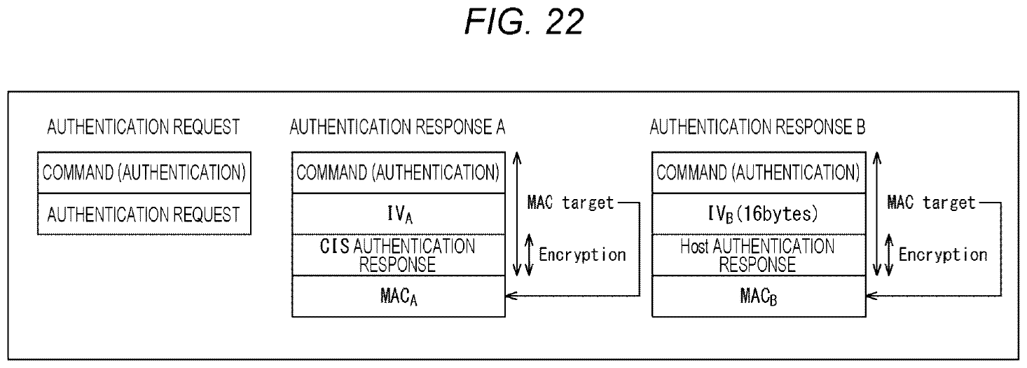

FIG. 22 illustrates a format of the authentication request generated and transmitted by the host 2. The format of the authentication request includes a command (authentication) and an authentication request. As described with reference to FIG. 20, the CIS 1 that has received such an authentication request writes data of the command (authentication) to the communication information register 312, and writes data of the authentication request (in FIG. 20, data corresponding to the authentication data) to the functional safety/security data region 313.

In step S22 (FIG. 21), the CIS 1 generates an authentication response A and writes the authentication response A to the functional safety/security data region 313. In response to a read request from the host 2, the CIS 1 reads the authentication response A from the functional safety/security data region 313 and outputs the authentication response A to the host 2. The host 2 receives and processes the authentication response A from the CIS 1 in step S12, and authenticates the CIS 1.

A format of the authentication response A generated in the CIS 1 and read by the host 2 is illustrated in FIG. 22. The format of the authentication response A includes a command (authentication), IVA, a CIS authentication response, and MACA. The CIS authentication response is encrypted data. The MACA is MAC data generated with a command (authentication), IVA, and a CIS authentication response as computation targets.

As described with reference to FIG. 20, the CIS 1 writes data of the command (authentication) to the communication information register 312, writes data of the IVA, the CIS authentication response, and the MACA (in FIG. 20, data corresponding to the authentication data) to the functional safety/security data region 313, reads the written data in response to a request from the host 2, and outputs the written data to the host 2.

In step S13 (FIG. 21), the host 2 generates an authentication response B and transmits the authentication response B to the CIS 1. The CIS 1 receives the authentication response B transmitted from the host 2 in step S23, executes processing such as writing in the functional safety/security data region 313, and authenticates the host 2.

FIG. 22 illustrates a format of the authentication response B generated and transmitted by the host 2. The format of the authentication response B includes a command (authentication), an IVB, a Host authentication response, and a MACB. The Host authentication response is encrypted data. The MACB is MAC data generated with a command (authentication), IVB, and a Host authentication response as computation targets.

As described with reference to FIG. 20, the CIS 1 writes data of the command (authentication) to the communication information register 312, and writes data of the IVB, the Host authentication response, and the MACB (in FIG. 20, data corresponding to the authentication data) to the functional safety/security data region 313.

In this manner, the CIS 1 and the host 2 each perform authentication.

### Transmission Procedure of Security Data (MAC Mode and CRC Mode)

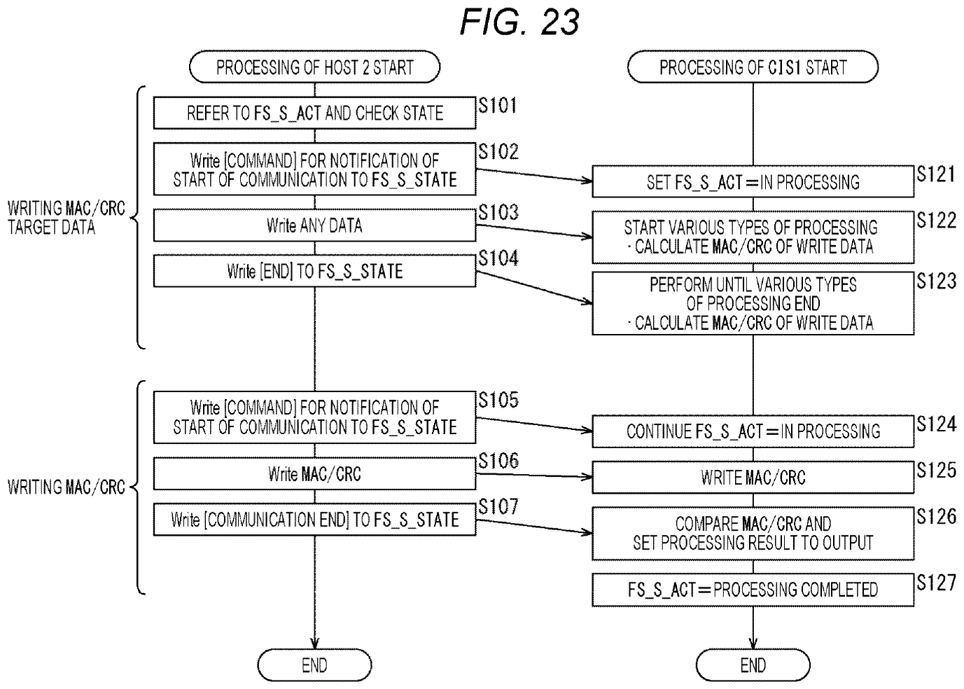

A procedure of transmitting the functional safety/security data from the host 2 to the CIS 1 will be described with reference to a flowchart of FIG. 23. The flowchart illustrated in FIG. 23 is a case where a MAC command or a CRC command is transmitted, and illustrates a procedure when target data is written to the register 130 in the MAC mode or the CRC mode.

First, in the CIS 1 and the host 2, processing for writing target data of MAC/CRC, for example, setting information is executed. In step S101, the host 2 refers to the processing state FS_S_ACT and checks the state.

As described with reference to FIG. 13, for example, the processing state FS_S_ACT is data indicating Active (in processing) when it is High, and is data indicating not Active when it is Low. In a case where the host 2 confirms that the processing state FS_S_ACT is Low, is not Active (not in a state of performing other processing), and it is a state where processing can be accepted, the processing proceeds to step S102.

In step S102, the host 2 generates [command] for notification of start of communication in the CRC mode or the MAC mode in the FS_S_STATE, and transmits the command to the CIS 1. For example, a status FS_S_STATE=CRC_REGW indicating a request to start writing the setting information to the sensor register 311 in the CRC mode is generated and transmitted.

In step S121, in a case of receiving the [command] for notification of start of communication in the CRC mode or the MAC mode from the host 2, the CIS 1 sets FS_S_ACT to be in processing.

As described with reference to FIGS. 15 and 16, the CIS 1 writes the received command to the communication information register 312. In a case where, by writing the command, a mode indicated by the command, for example, the command (CRC) is written to the communication information register 312, it is in the CRC mode, and in a case where the command (MAC) is written, the MAC mode is set.

In step S103, the host 2 generates any data, for example, the target data described with reference to FIGS. 15 and 16, and transmits the generated target data to the CIS 1. In step S122, upon receiving the target data from the host 2, the CIS 1 starts various types of processing. For example, the CIS 1 writes the received target data to the sensor register 311 as described with reference to FIGS. 15 and 16. Furthermore, the CIS 1 generates CRC data or MAC data with the command written to the register 130 and the target data as computation targets. The generated CRC data or MAC data is written in the functional safety/security data region 313.

In step S104, the host 2 generates communication information indicating [end] in the FS_S_STATE and transmits the communication information to the CIS 1. For example, a status FS_S_STATE=0 indicating a request to end writing the setting information to the sensor register 311 in the CRC mode is generated and transmitted.

In step S123, upon receiving a command to end writing the setting information from the host 2, the CIS 1 performs the various types of processing started in step S122 until the various types of processing end. Then, after the processing ends, the CIS 1 sets the operation mode value of the FS_S_STETE register of the communication information register 312 to 0.

In this manner, the processing related to writing of the MAC/CRC target data is performed between the CIS 1 and the host 2.

When the writing of the target data ends, processing for writing the MAC/CRC is executed in the CIS 1 and the host 2. In step S105, the host 2 generates [command] for notification of start of communication in the CRC mode or the MAC mode in the FS_S_STATE, and transmits the command to the CIS 1. For example, a status FS_S_STATE=CRC_DATAW indicating a request to start writing security data in the CRC mode is generated and transmitted as the communication information.

In step S124, upon receiving a communication start request from the host 2, the CIS 1 sets a state of FS_S_ACT=in processing.

In step S106, the host 2 generates and transmits MAC data or CRC data. In step S125, the CIS 1 writes the received MAC data or CRC data in the functional safety/security data region 313.

In step S107, the host 2 generates communication information indicating [communication end] in the FS_S_STATE, and transmits the communication information to the CIS 1. For example, a status FS_S_STATE=0 indicating a request to end writing the MAC data or the CRC data to the functional safety/security data region 313 is generated and transmitted.

In step S126, upon receiving a command indicating the end of communication from the host 2, the CIS 1 compares the MAC data or the CRC data generated in step S122 with the MAC data or the CRC data supplied from the host 2, and sets the processing result to output. When the comparison of the MAC data or the comparison of the CRC data ends and the comparison result is output to the host 2, the processing proceeds to step S127.

In step S127, FS_S_ACT is set to processing completed.

### Transmission Procedure of Security Data (Encryption Mode)

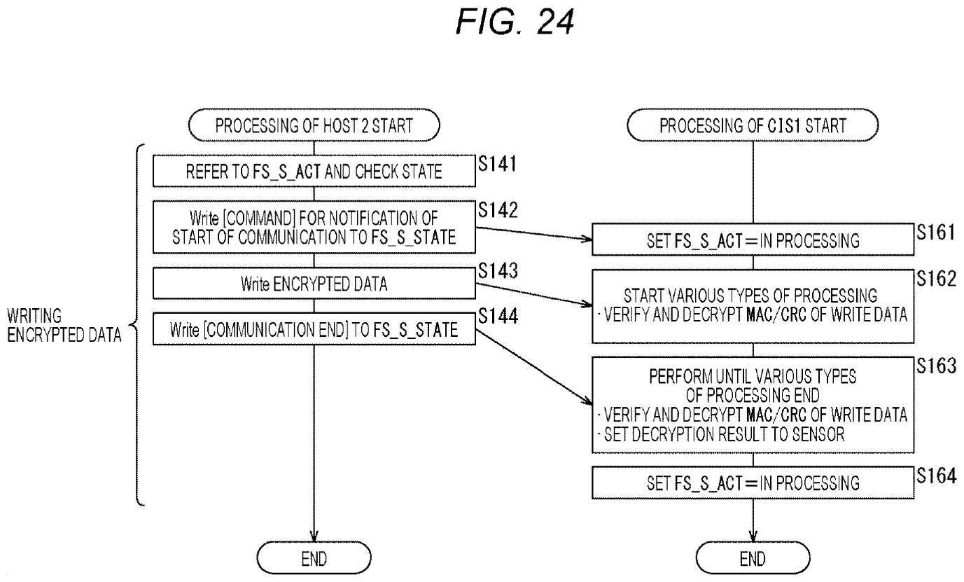

A procedure of transmitting functional safety/security data from the host 2 to the CIS 1 will be described with reference to a flowchart of FIG. 24. The flowchart illustrated in FIG. 24 illustrates a case where an encryption command is transmitted, and illustrates a procedure when encrypted data is written to the register 130 in the encryption mode.

In the CIS 1 and the host 2, processing for writing encrypted data is executed. In step S141, the host 2 refers to the processing state FS_S_ACT and checks the state. In a case where the host 2 confirms that the processing state FS_S_ACT is Low and it is a state where processing can be accepted, the host 2 advances the processing to step S142.

In step S142, the host 2 generates [command] for notification of start of communication in the encryption mode in the FS_S_STATE, and transmits the command to the CIS 1. For example, the status FS_S_STATE=USERDEF_DATAW indicating a request to start writing encrypted data to the functional safety/security data region 313 in the encryption mode is generated and transmitted.

In step S161, in a case of receiving the [command] for notification of start of communication in the encryption mode from the host 2, the CIS 1 sets FS_S_ACT=in processing. As described with reference to FIG. 17, the CIS 1 writes the received command (in FIG. 17, corresponding to the command (encryption)) to the communication information register 312.

In step S143, the host 2 generates encrypted data and transmits the encrypted data to the CIS 1. In step S162, upon receiving the encrypted data from the host 2, the CIS 1 starts various types of processing. For example, as described with reference to FIG. 17, the CIS 1 writes the received encrypted data in the functional safety/security data region 313. Furthermore, as described with reference to FIG. 17, the CIS 1 also receives data such as the total data size, the IV, and the MAC together with the encrypted data, and writes these pieces of data in the functional safety/security data region 313.

As the various types of processing, the CIS 1 verifies the data written in the functional safety/security data region 313 using the MAC. In a case where the CRC is received, the CRC is used to verify the data. Furthermore, the CIS 1 decrypts the encrypted data, and in a case where the decrypted data is, for example, setting information, performs setting based on the setting information (processing of step S163).

In step S144, the host 2 generates communication information indicating [communication end] in the FS_S_STATE, and transmits the communication information to the CIS 1. For example, a status FS_S_STATE=0 indicating a request to end writing the encrypted data to the functional safety/security data region 313 is generated and transmitted.

In step S163, upon receiving a command indicating the end of communication from the host 2, the CIS 1 writes the command to the communication information register 312, and in a case where the processing started in step S162 has not ended, the CIS 1 continues the processing until the processing ends. The CIS 1 sets (reflects) the decryption result of the encrypted data. After such processing ends, the CIS 1 sets FS_S_ACT=processing completed in step S164.

### Reception Procedure of Security Data (MAC Mode and CRC Mode)

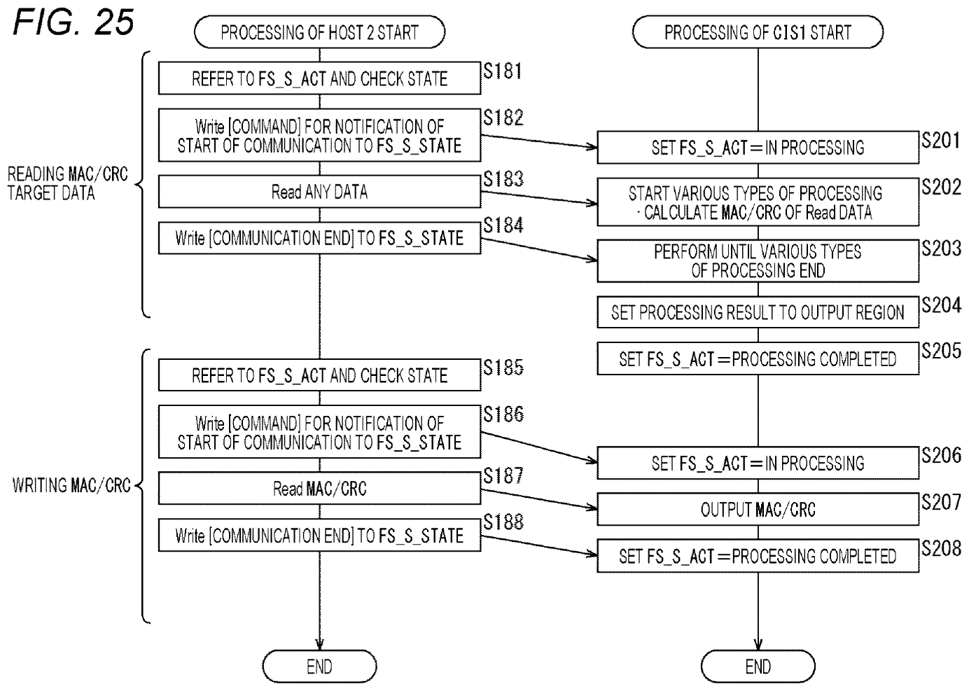

A procedure when the host 2 receives the functional safety/security data from the CIS 1 will be described with reference to a flowchart of FIG. 25. The flowchart illustrated in FIG. 25 is a case of a MAC or CRC command, and illustrates a procedure when target data of the MAC or CRC is read.

First, in the CIS 1 and the host 2, processing for reading the MAC/CRC target data is executed. In step S181, the host 2 refers to the processing state FS_S_ACT and checks the state. In a case where the host 2 confirms that the processing state FS_S_ACT is Low and it is a state where processing can be accepted, the host 2 advances the processing to step S182.

In step S182, the host 2 generates [command] for notification of start of communication in the CRC mode or the MAC mode in the FS_S_STATE, and transmits the command to the CIS 1. For example, a status FS_S_STATE=CRC_REGR indicating a request to start reading the setting information from the sensor register 311 in the CRC mode is generated and transmitted.

In step S201, upon receiving the [command] for notification of start of communication in the CRC mode or the MAC mode from the host 2, the CIS 1 sets FS_S_ACT=in processing. As described with reference to FIGS. 15 and 16, the CIS 1 writes the received command to the communication information register 312.

In step S183, the host 2 transmits an instruction to read data desired to be read to the CIS 1. In the CIS 1, various processes are started in step S202. For example, the CIS 1 reads the setting information written in the sensor register 311 in response to the read request from the host 2, and outputs the setting information to the host 2.

The CIS 1 generates MAC data with target data and a command (MAC) that are set as a read target as computation targets, or CRC data with target data and a command (CRC) that are set as a read target as computation targets. The generated MAC data or CRC data is written in the functional safety/security data region 313.

In step S184, the host 2 generates communication information indicating [communication end] in the FS_S_STATE, and transmits the communication information to the CIS 1. For example, a status FS_S_STATE=0 indicating a request to end writing the setting information to the sensor register 311 in the CRC mode is generated and transmitted.

In step S203, when a command to end reading the setting information is received from the host 2, in a case where the various types of processing started in step S202 are not ended, the CIS 1 continues the various types of processing until the various types of processing end. Then, after the processing ends, the CIS 1 sets the processing result in the output region in step S204, and sets the processing state FS_S_ACT=processing completed in step S205.

In this manner, the processing related to reading of the MAC/CRC target data is performed between the CIS 1 and the host 2.

When the reading of the target data ends, processing for reading the MAC/CRC is executed in the CIS 1 and the host 2. In step S185, the state is checked with reference to the processing state FS_S_ACT. In a case where the host 2 confirms that the processing state FS_S_ACT is Low and it is a state where processing can be accepted, the host 2 advances the processing to step S186.

In step S186, the host 2 generates [command] for notification of start of communication in the CRC mode or the MAC mode in the FS_S_STATE, and transmits the command to the CIS 1. For example, a status FS_S_STATE=CRC_DATAR indicating a request to start reading the CRC data to the functional safety/security data region 313 in the CRC mode is generated and transmitted. In step S206, the CIS 1 sets FS_S_ACT=in processing.

In step S187, the host 2 instructs the CIS 1 to read the MAC data or the CRC data. In step S207, the CIS 1 reads MAC data or CRC data written in the functional safety/security data region 313, and outputs the data to the host 2.

In step S188, the host 2 generates communication information indicating [communication end] in the FS_S_STATE, and transmits the communication information to the CIS 1. In step S208, upon receiving a command indicating the end of communication from the host 2, the CIS 1 sets FS_S_ACT=processing completed.

In this manner, the processing related to reading of the MAC/CRC data is performed between the CIS 1 and the host 2.

### Reception Procedure of Security Data (Encryption Mode)

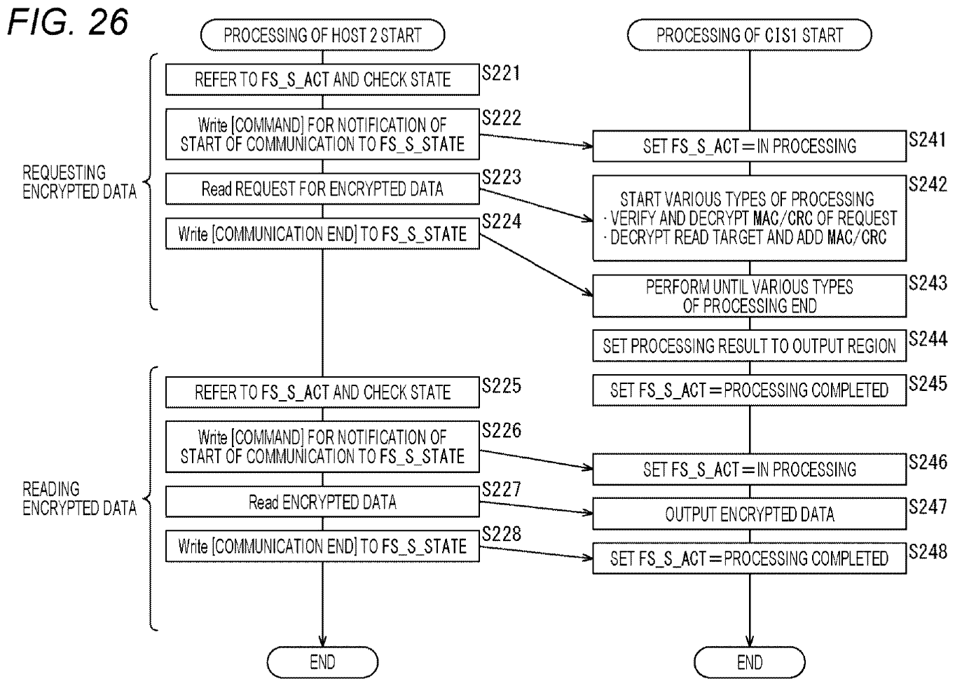

A procedure when the host 2 receives the functional safety/security data from the CIS 1 will be described with reference to a flowchart of FIG. 26. The flowchart illustrated in FIG. 26 is a case of an encryption command, and illustrates a procedure when the encrypted data is read.

In the CIS 1 and the host 2, processing related to a request for reading encrypted data is executed. In step S221, the host 2 refers to the processing state FS_S_ACT and checks the state. In a case where the host 2 confirms that the processing state FS_S_ACT is Low and it is a state where processing can be accepted, the host 2 advances the processing to step S222.

In step S222, the host 2 generates [command] for notification of start of communication in the encryption mode in the FS_S_STATE, and transmits the command to the CIS 1. For example, the status FS_S_STATE=USERDEF_DATAW indicating a request to start reading encrypted data to the functional safety/security data region 313 in the encryption mode is generated and transmitted.

In step S241, upon receiving the [command] for notification of start of communication in the encryption mode from the host 2, the CIS 1 sets FS_S_ACT=in processing. As described with reference to FIG. 17, the CIS 1 writes the received command to the communication information register 312.

In step S223, the host 2 transmits a request for reading data (target data) desired to be read to the CIS 1. In the CIS 1, various types of processing are started in step S242. For example, the MAC data or CRC data of the request is verified, and the encrypted data is decrypted.

The CIS 1 reads target data instructed to be read from the host 2, for example, setting information from the sensor register 311, encrypts the read target data, and writes the encrypted target data as encrypted data in the functional safety/security data region 313. The MAC data or CRC data for the written encrypted data is generated and written in the functional safety/security data region 313.

In step S224, the host 2 generates communication information indicating [communication end] in the FS_S_STATE, and transmits the communication information to the CIS 1. For example, a status FS_S_STATE=0 indicating the end of reading the setting information from the sensor register 311 in the encryption mode is generated and transmitted.

In step S243, upon receiving a command to end reading the setting information from the host 2, the CIS 1 continues to execute the various types of processing started in step S242 until the various types of processing end. Then, after the processing ends, the CIS 1 sets the processing result in the output region in step S244, and sets the processing state FS_S_ACT=processing completed in step S245.

In this manner, the processing related to the request for reading encrypted data is performed between the CIS 1 and the host 2.

In the CIS 1 and the host 2, processing for reading encrypted data is executed. In step S225, the state is checked with reference to the processing state FS_S_ACT. In a case where the host 2 confirms that the processing state FS_S_ACT is Low and it is a state where processing can be accepted, the host 2 advances the processing to step S226.

In step S226, the host 2 generates [command] for notification of start of communication in the encryption mode in the FS_S_STATE, and transmits the command to the CIS 1. In step S246, the CIS 1 sets FS_S_ACT=in processing.

In step S227, the host 2 instructs reading of encrypted data. In step S247, the CIS 1 reads encrypted data written in the functional safety/security data region 313, and outputs the read encrypted data to the host 2.

In step S228, the host 2 generates communication information indicating [communication end] in the FS_S_STATE, and transmits the communication information to the CIS 1. In step S248, upon receiving a command indicating the end of communication from the host 2, the CIS 1 sets FS_S_ACT=processing completed.

In this manner, the processing related to reading of the encrypted data is performed between the CIS 1 and the host 2.

### Transmission Procedure of Authentication Command

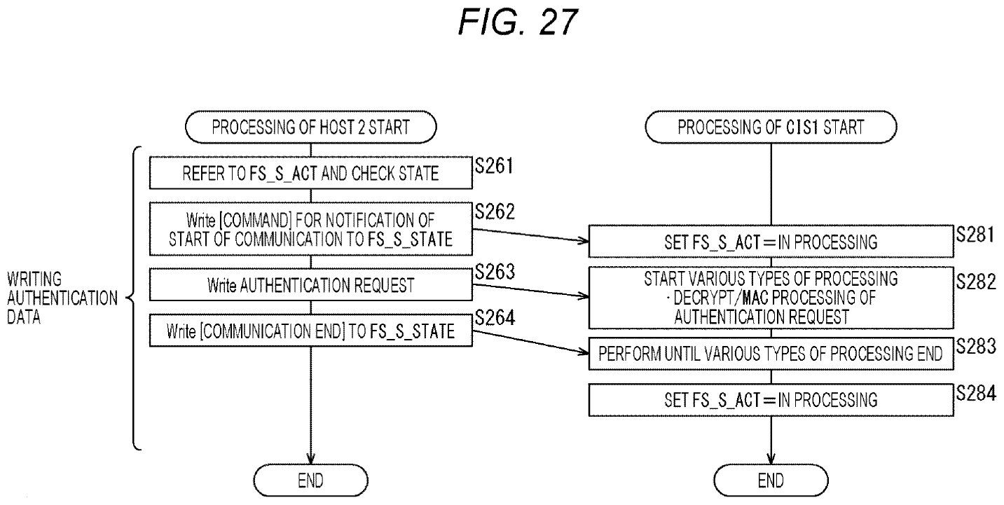

A procedure in a case where the authentication data is transmitted from the host 2 to the CIS 1 will be described with reference to a flowchart of FIG. 27. The flowchart illustrated in FIG. 27 is a case of the authentication command, and illustrates a procedure when the authentication data is written.

In the CIS 1 and the host 2, processing for writing the authentication data is executed. In step S261, the host 2 refers to the processing state FS_S_ACT and checks the state. In a case where the host 2 confirms that the processing state FS_S_ACT is Low and it is a state where processing can be accepted, the host 2 advances the processing to step S262.

In step S262, the host 2 generates [command] for notification of start of communication in the authentication mode in the FS_S_STATE, and transmits the command to the CIS 1. In step S281, in a case of receiving the [command] for notification of start of communication in the authentication mode from the host 2, the CIS 1 sets FS_S_ACT=in processing. As described with reference to FIG. 20, the CIS 1 writes the received command (in FIG. 20, corresponding to the command (authentication)) to the communication information register 312.

In step S263, the host 2 generates data instructing writing of an authentication request and transmits the data to the CIS 1. In step S282, upon receiving an authentication request from the host 2, the CIS 1 starts various processes. For example, the CIS 1 decrypts an authentication request and processes (verifies) MAC data.

In step S264, the host 2 generates communication information indicating [communication end] in the FS_S_STATE, and transmits the communication information to the CIS 1. In step S283, upon receiving a command indicating the end of communication from the host 2, the CIS 1 continues the processing started in step S282 until the end. After such processing ends, the CIS 1 sets FS_S_ACT =processing completed in step S284.

### Reception Procedure of Authentication Data

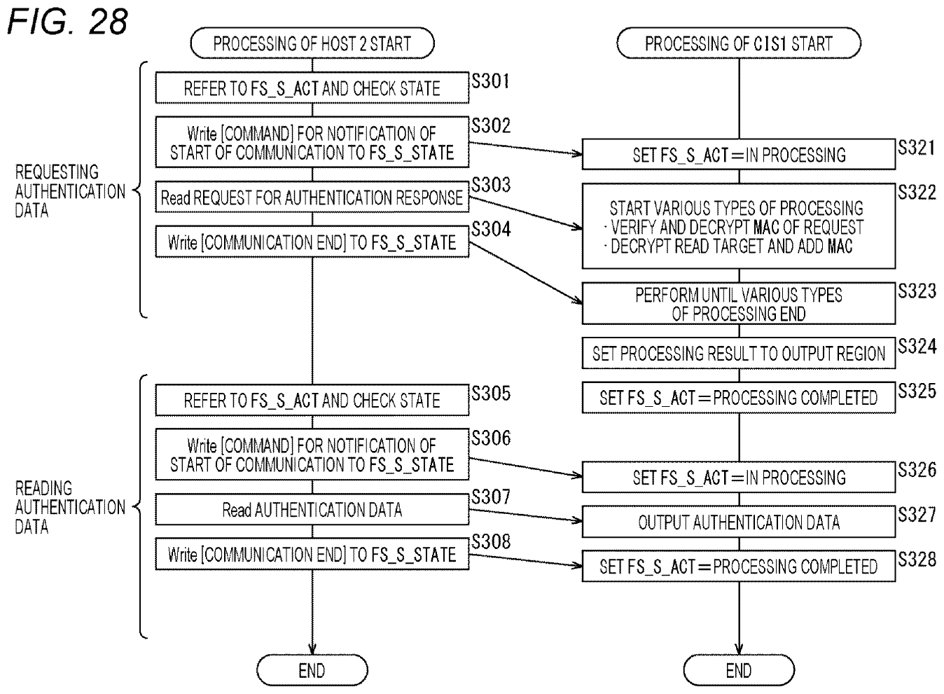

A procedure when the host 2 receives the authentication data from the CIS 1 will be described with reference to a flowchart of FIG. 28. The flowchart illustrated in FIG. 28 is a case of the authentication command, and illustrates a procedure when the authentication data is read.

In the CIS 1 and the host 2, processing related to a request for reading the authentication data is executed. In step S301, the host 2 refers to the processing state FS_S_ACT and checks the state. In a case where the host 2 confirms that the processing state FS_S_ACT is Low and it is a state where processing can be accepted, the host 2 advances the processing to step S302.

In step S302, the host 2 generates [command] for notification of start of communication in the authentication mode in the FS_S_STATE, and transmits the command to the CIS 1. In step S321, upon receiving the [command] for notification of start of communication in the authentication mode from the host 2, the CIS 1 sets FS_S_ACT=in processing. As described with reference to FIG. 20, the CIS 1 writes the received command to the communication information register 312.

In step S303, the host 2 transmits a request for reading the authentication data desired to be read to the CIS 1. In the CIS 1, various processes are started in step S322. For example, the MAC data of the request is verified and the request is decrypted. Furthermore, the CIS 1 encrypts the data to be read, generates MAC data, and writes the MAC data in the functional safety/security data region 313.

In step S304, the host 2 generates communication information indicating [communication end] in the FS_S_STATE, and transmits the communication information to the CIS 1. In step S323, upon receiving a request to end communication from the host 2, the CIS 1 continues the various types of processing started in step S322 until the various types of processing end. Then, after the processing ends, the CIS 1 sets the processing result in the output region in step S324, and sets the processing state FS_S_ACT=processing completed in step S325.

In this manner, the processing related to the request for reading the authentication data is performed between the CIS 1 and the host 2.

In the CIS 1 and the host 2, processing for reading the authentication data is executed. In step S305, the host 2 refers to the processing state FS_S_ACT and checks the state. In a case where the host 2 confirms that the processing state FS_S_ACT is Low and it is a state where processing can be accepted, the host 2 advances the processing to step S306.

In step S306, the host 2 generates [command] for notification of start of communication in the authentication mode in the FS_S_STATE, and transmits the command to the CIS 1. In step S326, the CIS 1 sets FS_S_ACT=in processing.

In step S307, the host 2 instructs to read the authentication data. In step S327, the CIS 1 reads the authentication data written in the functional safety/security data region 313, and outputs the authentication data to the host 2.

In step S308, the host 2 generates communication information indicating [communication end] in the FS_S_STATE, and transmits the communication information to the CIS 1. In step S328, upon receiving a command indicating the end of communication from the host 2, the CIS 1 sets FS_S_ACT=processing completed. In this manner, the processing related to reading of the authentication data is performed between the CIS 1 and the host 2.

As described with reference to FIGS. 23 to 28, the host 2 determines whether or not the CIS 1 is in a state of accepting processing, for example, whether or not the CIS 1 operates in a predetermined mode such as a CRC mode or an encryption mode, and is not in a state of not accepting processing in a mode other than the mode, and then outputs a write or read command. When the CIS 1 operates in the predetermined mode, writing to the register 130 and reading from the register 130 in the mode are performed.

By designating the mode, in other words, by managing the mode-designating command in the communication information register 312, even in a configuration in which the register 130 is shared and used in a plurality of modes, the operation can be performed in the designated mode, and the limited register space can be effectively used in the plurality of modes.

When the CIS 1 operates in the predetermined mode, an operation in another mode is not instructed, and thus it is possible to prevent data in the operating mode from being overwritten with data in another mode in a predetermined region of the register 130.

According to the present technology, the register 130 corresponding to a plurality of modes, in other words, a plurality of functions can be provided, and with the CIS 1 including such a register 130, the CIS 1 corresponding to a plurality of functions can be provided. Since functions related to communication security can be handled as a plurality of functions, the security of communication between the CIS 1 and the host 2 can be enhanced.

### Configuration and Processing of CIS When Including Fuse

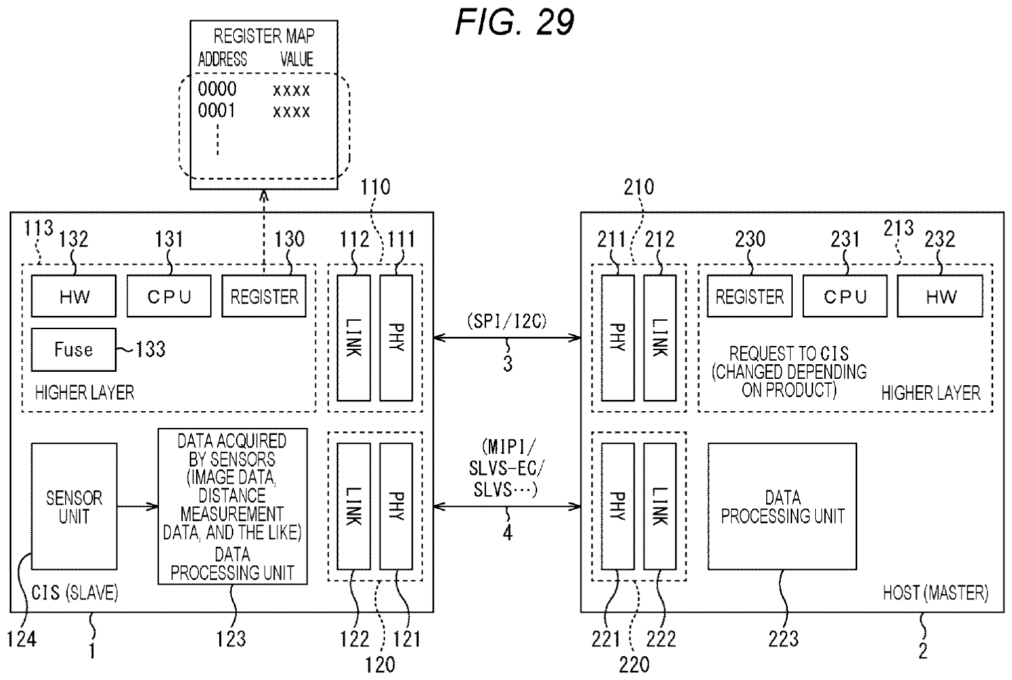

FIG. 29 schematically illustrates another overall configuration example of the data transmission system. The data transmission system is different from the data transmission system illustrated in FIG. 1 in that a Fuse 133 is added to the CIS 1 of the data transmission system illustrated in FIG. 29, and the other points are similar thereto.

As described above, the CIS 1 can be a CIS 1 corresponding to a plurality of functions. By providing the Fuse 133, even in the CIS 1 that supports a plurality of functions, it is possible to customize to the CIS 1 that can selectively support a necessary function among the functions. For example, for each user who uses the CIS 1, customization such as corresponding to a function desired by the user and not corresponding to a function not desired by the user can be performed on the CIS 1.

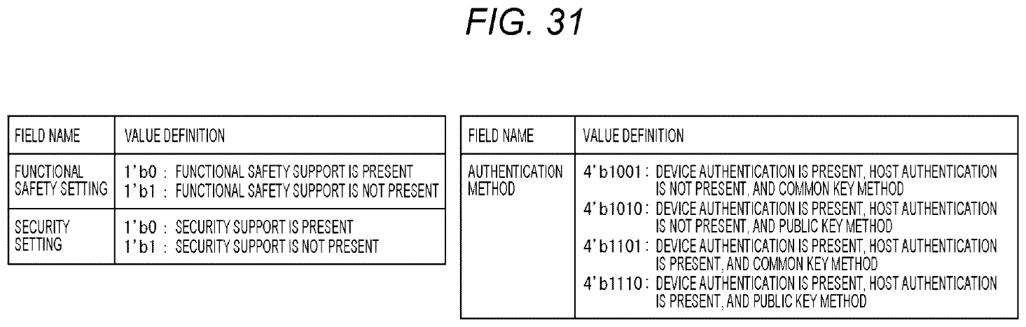

In the register 130, as in the case described above, regions capable of corresponding to a plurality of functions are defined by the same address. The CPU 131 and the HW 132 make a determination on the basis of an internal operation state, a Fuse value, and an external command, and switch a field of the register space of the register 130. The Fuse 133 has a function selection field (described later with reference to FIG. 31), and switches the definition of the register space according to the value of the field.

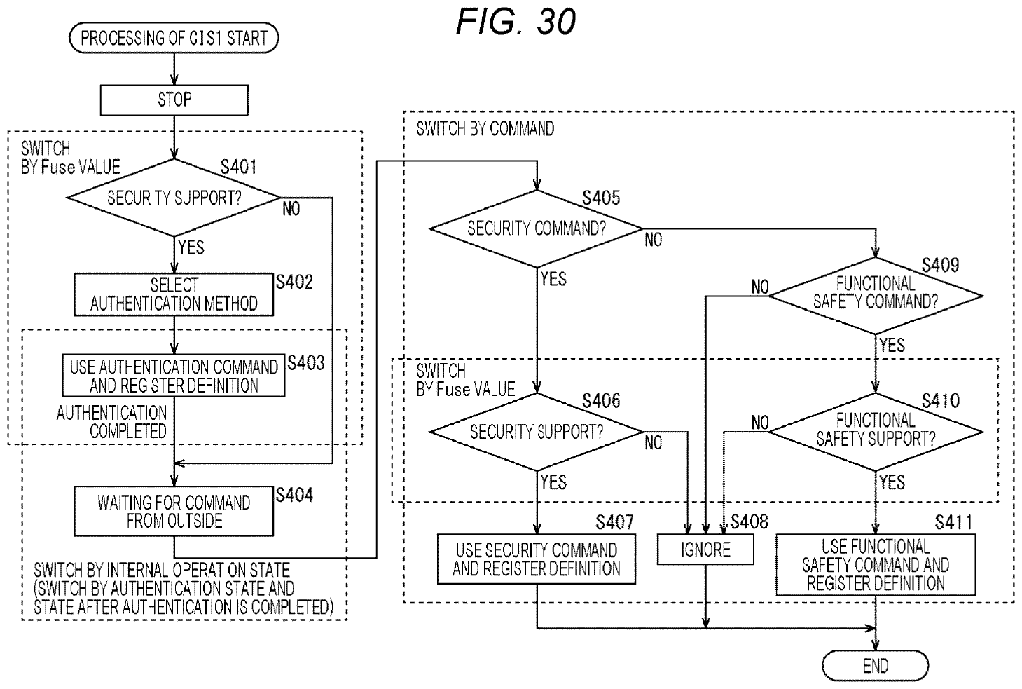

The operation of the CIS 1 including the Fuse 133 will be described with reference to a flowchart of FIG. 30.

In a case where the CIS 1 is in a stopped state, it is determined in step S401 whether or not security is supported. This determination is performed by the Fuse 133, and is switched by the Fuse value set to the Fuse 133. The Fuse value will be described with reference to FIG. 31.

FIG. 31 is a diagram illustrating an example of a Fuse value. A table in which a field name and a setting value are associated with each other is illustrated. In a case where the field name is a functional safety setting and the setting value is “1′b01”, it indicates that functional safety is supported, and in a case where the setting value is “1′b1”, it indicates that functional safety is not supported. Supporting functional safety means that communication in the CRC mode described above can be performed.

In a case where the field name is a security setting and the setting value is “1′b0”, it indicates that security is supported, and in a case where the setting value is “1′b1”, it indicates that security is not supported. Supporting security means supporting at least one or both of the MAC mode described above and the encryption mode.

In a case where the field name is an authentication method and the setting value is “4′b1001”, it indicates that device authentication is performed, host authentication is not performed, and a common key method is performed, and in a case where the field name is “4′b1010”, it indicates that the device authentication is performed, the host authentication is not performed, and the public key method is performed. Furthermore, in a case where the field name is the authentication method and the setting value is “4′b1101”, it indicates that the device authentication is performed, the host authentication is performed, and the common key method is performed, and in a case of “4′b1110”, it indicates that the device authentication is performed, the host authentication is performed, and the public key method is performed.

The Fuse 133 has a Fuse value as information regarding a supported communication mode. The Fuse 133 functions as a setting unit in which whether or not a communication mode is supported is set, and in a case where a command in a communication mode other than the set communication mode is received, the processing of changing the register definition is not executed as described later.

In step S401, the Fuse value is referred to, and in a case where the setting value is “1′b0”, it is determined that security is supported, and in a case where the setting value is “1′b1”, it is determined that security is not supported. In a case where it is determined in step S401 that security is supported, the processing proceeds to step S402, and in a case where it is determined that security is not supported, the processing of steps S402 and S403 is skipped, and the processing proceeds to step S405.

In step S402, an authentication method is selected. The selected authentication method is also switched by the Fuse value, and is selected on the basis of the setting value of the Fuse value. In step S403, the authentication command and the register definition are used. In step S403, the authentication processing described with reference to FIG. 21 is executed, so that processing in which the CIS 1 authenticates the host 2 and the host 2 authenticates the CIS 1 is performed.

When the authentication ends, the processing proceeds to step S404, and a command from the outside is awaited. The processing so far may be performed once when the CIS 1 and the host 2 start communication. The state of waiting for a command from the outside is a state in which switching is appropriately executed in an internal operation state (an authentication state and a state after completion of authentication).

When a command is received in a state of waiting for a command from the outside, the processing proceeds to step S405. The processing after step S405 is processing performed every time a command is received.

In step S405, it is determined whether or not the security command has been received. In a case where it is determined in step S405 that the security command has been received, the processing proceeds to step S406.

In step S406, it is determined whether or not security is supported. This determination is made with reference to the Fuse value as in step S401. Since it is determined in step S401 whether or not security is supported, the processing in step S406 may be executed using the determination result.

In a case where it is determined in step S406 that security is supported, the processing proceeds to step S407, and the register definition is used according to the received security command. For example, if the security command designates a MAC mode, the register definition is set to MAC mode and register 130 is used.

On the other hand, in a case where it is determined in step S406 that security is not supported, the processing proceeds to step S408. In step S408, no processing is performed on the received security command, and the received security command is ignored.

For example, the received command is written in the communication information register 312, and the definition of the register space of the register 130 is set in the communication mode corresponding to the command. However, in a case where the processing proceeds to step S408, such processing is not executed. Therefore, in a case where a command of a function set as a non-corresponding function is received by the Fuse 133, the communication mode is not set to the communication mode indicated by the command, and the definition of the register space is not changed. That is, the function is selected by the Fuse 133.

On the other hand, in a case where it is determined in step S405 that the received command is not the security command, the processing proceeds to step S409. In step S409, it is determined whether or not the received command is a functional safety command. In a case where it is determined in step S409 that the received command is a functional safety command, the processing proceeds to step S410.

In step S410, it is determined whether or not functional safety is supported. In a case where it is determined in step S410 that functional safety is supported, the processing proceeds to step S411. In step S411, the register definition is used by the received functional safety command. For example, in a case where the functional safety command designates a CRC mode, the register definition is set to CRC mode and register 130 is used.

On the other hand, in a case where it is determined in step S409 that the received command is not a functional safety command, or in a case where it is determined in step S410 that functional safety is not supported, the processing proceeds to step S408. In step S408, no processing is performed on the received command, and the received command is ignored.

In this manner, by providing the Fuse 133, the definition of the register space at the same address of the register 130 can be changed by a command from the host 2, and the definition of the register space at the same address of the register 130 can be changed by switching using the Fuse value of the Fuse 133.

In this manner, by providing the Fuse 133, a configuration can be made in which a function that can be supported by the Fuse 133 can be selected. Even in the CIS 1 that supports many functions, by setting the Fuse value, the corresponding function can be selected and the CIS 1 can be customized according to the needs of the customer who uses the CIS 1.

According to the present technology, it is possible to cope with the functional safety function and the security function necessary for the product without changing the design of the sensor (CIS 1) or the existing interface (IF). In addition, by sharing and switching the register in a plurality of modes (functions), it is possible to support a plurality of modes (functions). Therefore, it is possible to provide a sensor that effectively uses a limited register space and supports a plurality of functions.

### Recording Medium

The above-described series of processing can be performed by hardware or software. In a case where the series of processing is executed by software, a program constituting the software is installed in a computer. Here, examples of the computer include a computer incorporated in dedicated hardware, and for example, a general-purpose personal computer that can execute various functions by installing various programs.

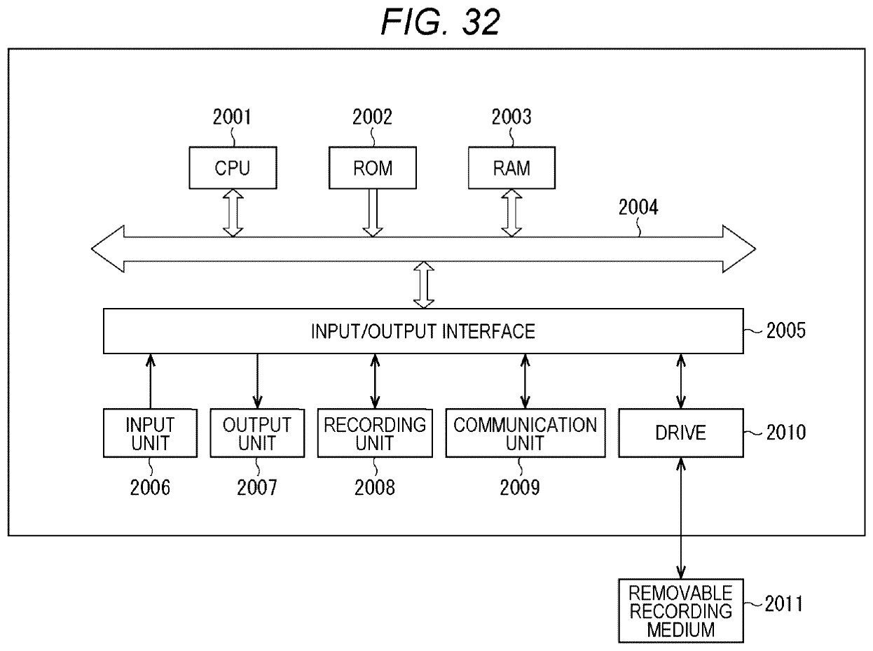

FIG. 32 is a block diagram illustrating a configuration example of hardware of a computer that executes the above-described series of processing by a program. In the computer, a central processing unit (CPU) 2001, a read only memory (ROM) 2002, and a random access memory (RAM) 2003 are connected to one another by a bus 2004. An input/output interface 2005 is further connected to the bus 2004. An input unit 2006, an output unit 2007, a storage unit 2008, a communication unit 2009, and a drive 2010 are connected to the input/output interface 2005.

The input unit 2006 includes a keyboard, a mouse, a microphone, and the like. The output unit 2007 includes a display, a speaker, and the like. The storage unit 2008 includes a hard disk, a nonvolatile memory, and the like. The communication unit 2009 includes a network interface and the like. The drive 2010 drives a removable medium 2011 such as a magnetic disk, an optical disk, a magneto-optical disk, or a semiconductor memory.

In the computer designed as described above, the CPU 2001 loads, for example, a program stored in the storage unit 2008 into the RAM 2003 via the input/output interface 2005 and the bus 2004, and executes the program, so that the series of processing described above is performed.

The program executed by the computer (CPU 2001) can be provided by being recorded in the removable medium 2011 as a package medium or the like, for example. Furthermore, the program can be provided via a wired or wireless transmission medium such as a local area network, the Internet, or digital satellite broadcasting.

In the computer, the program can be installed in the storage unit 2008 via the input/output interface 2005 by mounting the removable medium 2011 on the drive 2010. Furthermore, the program can be received by the communication unit 2009 via a wired or wireless transmission medium and installed in the storage unit 2008. Other than the above, the program can be installed beforehand into the ROM 2002 or the storage unit 2008.

Note that the program executed by the computer may be a program in which processing is performed in time series in the order described in the present specification or may be a program in which processing is performed in parallel or at necessary timing such as when a call is made.

In the present specification, the system represents the entire device including a plurality of devices.

Note that the effects described in the present description are merely examples and are not limited, and other effects may be provided.

Note that the embodiments of the present technology are not limited to the above-described embodiments, and various changes can be made without departing from the gist of the present technology.

Note that the present technology can also have the following configurations.

(1)

A data processing apparatus including:

a register including, as an address region, a setting region that stores setting information transmitted from a host, a security data region that stores security data for the setting information, and a communication information region that stores communication information with the host; and

a communication unit that performs register communication between the host and the register, in which

the data processing apparatus

writes communication mode information indicating at least one communication mode of the register communication in the communication information region in a case where the communication mode information is received from the host, and

sets a register definition for the same space of the register for each of the communication modes based on the communication mode information written in the communication information region.

(2)

The data processing apparatus according to (1) above, in which

the communication mode is any one of a mode in which encrypted data including the setting information is exchanged, a mode in which an error detection code related to the setting information is exchanged, a mode in which a message authentication code related to the setting information is exchanged, and a mode in which authentication data is exchanged.

(3)

The data processing apparatus according to (2) above, in which

in a case where a mode for exchanging encrypted data including the setting information is written in the communication information region, the encrypted data is stored in the security data region.

(4)

The data processing apparatus according to (2) or (3) above, in which

in a case where the mode in which an error detection code related to the setting information is exchanged is written in the communication information region, the error detection code is stored in the security data, and the setting information targeted for the error detection code is stored in the setting region.

(5)

The data processing apparatus according to any one of (2) to (4) above, in which

in a case where the mode in which a message authentication code related to the setting information is exchanged is written in the communication information region, the message authentication code is stored in the security data region, and the setting information targeted for the message authentication code is stored in the setting region.

(6)

The data processing apparatus according to any one of (2) to (5) above, in which

in a case where the mode in which authentication data is exchanged is written in the communication information region, the authentication data is stored in the security data region.

(7)

The data processing apparatus according to any one of (1) to (6) above, in which

the set register definition is not changed until a command indicating end of the communication mode is received from the host.

(8)

The data processing apparatus according to any one of (1) to (7) above, further including:

a setting unit in which whether or not the communication mode is supported is set, in which

the register definition is not changed in a case where a command in a communication mode other than the communication mode set in the setting unit is received.

(9)

A data processing method executed by a data processing apparatus including:

a register including, as an address region, a setting region that stores setting information transmitted from a host, a security data region that stores security data for the setting information, and a communication information region that stores communication information with the host; and

a communication unit that performs register communication between the host and the register,

the data processing method including:

writing communication mode information indicating at least one communication mode of the register communication in the communication information region in a case where the communication mode information is received from the host; and

setting a register definition for the same space of the register for each of the communication modes based on the communication mode information written in the communication information region.

(10)

A program for a computer that controls a data processing apparatus including:

a register including, as an address region, a setting region that stores setting information transmitted from a host, a security data region that stores security data for the setting information, and a communication information region that stores communication information with the host; and

a communication unit that performs register communication between the host and the register,

the program causing the computer to execute processing including:

writing communication mode information indicating at least one communication mode of the register communication in the communication information region in a case where the communication mode information is received from the host; and

setting a register definition for the same space of the register for each of the communication modes based on the communication mode information written in the communication information region.

### REFERENCE SIGNS LIST

1 CIS
2 Host
3 Transmission path
4 Transmission path
110 Communication unit
111 Physical layer
112 Link layer
113 Higher layer
120 Communication unit
123 Data processing unit
124 Sensor unit
130 Register
131 CPU
210 Communication unit
211 Physical layer
212 Link layer
213 Higher layer
220 Communication unit
223 Data processing unit
230 Register
231 CPU
232 Hardware
311 Sensor register
312 Communication information register
313 Security data region
410 Write determination unit
411 Register communication detection unit
412 Data computation unit
413 Error detection unit
414 Write counter control unit
430 Decryption unit
501 Processing state output terminal
502 Error output terminal

1. A data processing apparatus comprising:
a register including, as an address region, a setting region that stores setting information transmitted from a host, a security data region that stores security data for the setting information, and a communication information region that stores communication information with the host; and
a communication unit that performs register communication between the host and the register, wherein
the data processing apparatus
writes communication mode information indicating at least one communication mode of the register communication in the communication information region in a case where the communication mode information is received from the host, and
sets a register definition for a same space of the register for each of the communication modes based on the communication mode information written in the communication information region.

2. The data processing apparatus according to claim 1, wherein
the communication mode is any one of a mode in which encrypted data including the setting information is exchanged, a mode in which an error detection code related to the setting information is exchanged, a mode in which a message authentication code related to the setting information is exchanged, and a mode in which authentication data is exchanged.

3. The data processing apparatus according to claim 2, wherein
in a case where a mode for exchanging encrypted data including the setting information is written in the communication information region, the encrypted data is stored in the security data region.

4. The data processing apparatus according to claim 2, wherein
in a case where the mode in which an error detection code related to the setting information is exchanged is written in the communication information region, the error detection code is stored in the security data, and the setting information targeted for the error detection code is stored in the setting region.

5. The data processing apparatus according to claim 2, wherein
in a case where the mode in which a message authentication code related to the setting information is exchanged is written in the communication information region, the message authentication code is stored in the security data region, and the setting information targeted for the message authentication code is stored in the setting region.

6. The data processing apparatus according to claim 2, wherein
in a case where the mode in which authentication data is exchanged is written in the communication information region, the authentication data is stored in the security data region.

7. The data processing apparatus according to claim 1, wherein
the set register definition is not changed until a command indicating end of the communication mode is received from the host.

8. The data processing apparatus according to claim 1, further comprising:
a setting unit in which whether or not the communication mode is supported is set, wherein
the register definition is not changed in a case where a command in a communication mode other than the communication mode set in the setting unit is received.

9. A data processing method executed by a data processing apparatus including:
a register including, as an address region, a setting region that stores setting information transmitted from a host, a security data region that stores security data for the setting information, and a communication information region that stores communication information with the host; and
a communication unit that performs register communication between the host and the register,
the data processing method comprising:
writing communication mode information indicating at least one communication mode of the register communication in the communication information region in a case where the communication mode information is received from the host; and
setting a register definition for a same space of the register for each of the communication modes based on the communication mode information written in the communication information region.

10. A program for a computer that controls a data processing apparatus including:
a register including, as an address region, a setting region that stores setting information transmitted from a host, a security data region that stores security data for the setting information, and a communication information region that stores communication information with the host; and
a communication unit that performs register communication between the host and the register,
the program causing the computer to execute processing comprising:
writing communication mode information indicating at least one communication mode of the register communication in the communication information region in a case where the communication mode information is received from the host; and
setting a register definition for a same space of the register for each of the communication modes based on the communication mode information written in the communication information region.
